(19) United States
(12) Patent Application Publication
(10) Pub. No.: US 2026/0016818 A1
(43) Pub. Date: Jan. 15, 2026

(54) SENSOR INPUT BASED ANOMALY DETECTION

(71) Applicant: THE BOEING COMPANY, Arlington, VA (US)

(72) Inventors: Lijun Gao, Renton, WA (US); Shengyi Liu, Sammamish, WA (US); Evelyn Matheson, Bothell, WA (US)

(21) Appl. No.: 18/768,424

(22) Filed: Jul. 10, 2024

(51) Int. Cl. G05B 23/02

(52) U.S. Cl. CPC G05B 23/024; G05B 23/0264; G05B 23/0275

(57) ABSTRACT

A device includes a processor configured to receive sensor input from one or more sensors and to process the sensor input, using multiple neural networks, to generate corresponding output values. The neural networks include at least a first neural network trained to identify a first anomaly type and a second neural network trained to identify a second anomaly type. The processor is also configured to determine, based on first output values of the first neural network, whether a first anomaly detection criterion of the first anomaly type is satisfied. The processor is further configured to determine, based on second output values of the second neural network, whether a second anomaly detection criterion of the second anomaly type is satisfied. The processor is also configured to generate an anomaly output based on whether at least one of the first anomaly detection criterion or the second anomaly detection criterion is satisfied.

### FIELD OF THE DISCLOSURE

The present disclosure is generally related to anomaly detection based on sensor input.

### BACKGROUND

Anomalies, such as machine faults and degradation, can reduce performance. Off-line detection techniques cannot be used for real-time anomaly detection in machines that are in use. Unplanned maintenance and downtime interrupts normal operation and can be costly. Complex non-linear relationships in data can be difficult to determine procedurally, reducing a likelihood of early detection of anomalies.

### SUMMARY

In a particular implementation of the present disclosure, a device includes one or more processors configured to receive sensor input from one or more sensors. The one or more processors are further configured to process the sensor input, using multiple neural networks, to generate corresponding output values. The multiple neural networks include at least a first neural network trained to identify a first anomaly type and a second neural network trained to identify a second anomaly type that is distinct from the first anomaly type. The one or more processors are further configured to determine, based on first output values of the first neural network, whether a first anomaly detection criterion of the first anomaly type is satisfied. The first anomaly detection criterion is based on at least a first threshold number of sequential samples of the sensor input. The one or more processors are further configured to determine, based on second output values of the second neural network, whether a second anomaly detection criterion of the second anomaly type is satisfied. The second anomaly detection criterion is based on at least a second threshold number of sequential samples of the sensor input. The one or more processors are further configured to generate an anomaly output based on whether at least one of the first anomaly detection criterion or the second anomaly detection criterion is satisfied.

In another particular implementation of the present disclosure, a method includes receiving sensor input from one or more sensors. The method also includes processing the sensor input, using multiple neural networks, to generate corresponding output values. The multiple neural networks include at least a first neural network trained to identify a first anomaly type and a second neural network trained to identify a second anomaly type that is distinct from the first anomaly type. The method also includes determining, based on first output values of the first neural network, whether a first anomaly detection criterion of the first anomaly type is satisfied. The first anomaly detection criterion is based on at least a first threshold number of sequential samples of the sensor input. The method also includes determining, based on second output values of the second neural network, whether a second anomaly detection criterion is satisfied. The second anomaly detection criterion is based on a second threshold number of sequential samples of the sensor input. The method also includes generating an anomaly output based on whether at least one of the first anomaly detection criterion or the second anomaly detection criterion is satisfied.

In another particular implementation of the present disclosure, an aircraft includes an electrical machine. The aircraft also includes one or more sensors coupled to the electrical machine and configured to generate sensor input corresponding to operation of the electrical machine. The aircraft further includes an anomaly detector configured to process the sensor input, using multiple neural networks, to generate corresponding output values. The multiple neural networks include at least a first neural network trained to identify a first anomaly type and a second neural network trained to identify a second anomaly type that is distinct from the first anomaly type. The anomaly detector is also configured to determine, based on first output values of the first neural network, whether a first anomaly detection criterion of the first anomaly type is satisfied. The first anomaly detection criterion is based on at least a first threshold number of sequential samples of the sensor input. The anomaly detector is further configured to determine, second output values of the second neural network, whether a second anomaly detection criterion of the second anomaly type is satisfied. The second anomaly detection criterion is based on at least a second threshold number of sequential samples of the sensor input. The anomaly detector is also configured to generate an anomaly output based on whether at least one of the first anomaly detection criterion or the second anomaly detection criterion is satisfied.

The features, functions, and advantages described herein can be achieved independently in various implementations or may be combined in yet other implementations, further details of which can be found with reference to the following description and drawings.

### BRIEF DESCRIPTION OF THE DRAWINGS

FIG. 1 is a diagram that illustrates a system configured to perform sensor input based anomaly detection.

FIG. 2A is a diagram of an illustrative example of anomaly types detectable by an anomaly detector of the system of FIG. 1.

FIG. 2B is a diagram of an illustrative implementation of the anomaly detector of the system of FIG. 1.

FIG. 3 is a diagram of an illustrative aspect of operations of the anomaly detector of the system of FIG. 1.

FIG. 4 is a diagram of an illustrative aspect of operations of an anomaly detection neural network (ADNN) trainer configured to train the anomaly detector of the system of FIG. 1.

FIG. 5 is a diagram of an illustrative aspect of operations of the ADNN trainer of FIG. 4.

FIG. 6 is an illustration of a graph depicting training sensor input and reference output and a graph depicting ADNN output and the reference output.

FIG. 7 is an illustration of graphs depicting ADNN output of an ADNN for sensor input corresponding to various types of anomalies.

FIG. 8A is an illustration of a graph depicting ADNN output of an ADNN trained to detect turn-to-turn short faults for sensor input corresponding to turn-to-turn short faults.

FIG. 8B is an illustration of a graph depicting ADNN output of an ADNN trained to detect turn-to-turn faults for sensor input corresponding to ground short faults.

FIG. 8C is an illustration of a graph depicting ADNN output of an ADNN trained to detect turn-to-turn faults for sensor input corresponding to open circuit faults.

FIG. 8D is an illustration of a graph depicting ADNN output of an ADNN trained to detect turn-to-turn faults for sensor input corresponding to current imbalance.

FIG. 9 is a diagram that illustrates a flow chart of an example of method of sensor input based anomaly detection.

FIG. 10 is a flowchart illustrating an example of a life cycle of an aircraft that includes the anomaly detector of the system of FIG. 1.

FIG. 11 is a block diagram of a particular implementation of an aircraft that includes the anomaly detector of the system of FIG. 1.

FIG. 12 is a block diagram of a computing environment including a computing device configured to support aspects of computer-implemented methods and computer-executable program instructions (or code) according to the present disclosure.

### DETAILED DESCRIPTION

Anomalies, such as machine faults and degradation, can reduce performance. Off-line detection techniques cannot be used for real-time anomaly detection in machines that are in use. Unplanned maintenance and downtime interrupts normal operation and can be costly. Complex non-linear relationships in data can be difficult to determine procedurally, reducing a likelihood of early detection of anomalies.

Aspects disclosed herein present systems and methods for sensor input based anomaly detection. One or more sensors are coupled to an electrical machine and are configured to provide a sensor input to an anomaly detector. The anomaly detector includes multiple anomaly detection neural networks (ADNNs). Each ADNN is trained to identify a corresponding anomaly type. For example, a first ADNN is trained to identify a first anomaly type (e.g., turn-to-turn (TT) faults). In an example, a TT fault refers to a short circuit between some turns of the same phase of a stator winding of an electrical machine. The TT fault can occur due to aging and degradation of insulation. During a TT fault, different branches of the winding have different current levels, and the sensor input corresponds to (e.g., indicates) the different current levels. It should be understood that “TT fault” and “TT short fault” is used interchangeably herein.

The first ADNN is configured to process the sensor input to generate ADNN output that satisfies a first detection criterion of the first anomaly type when the electrical machine is experiencing events (e.g., a TT fault) associated with the first anomaly type. The anomaly detector, based at least in part on the ADNN output of the first ADNN, generates an anomaly output indicating that the first anomaly type is detected.

The anomaly detector can thus detect that the electrical machine is experiencing events associated with the first anomaly type in real-time without taking the electrical machine off-line. In some aspects, the first anomaly type can be detected early prior to the electrical machine becoming inoperable. The first ADNN is trained to identify complex relations of the sensor input to identify the first anomaly type. An ADNN can be added, upgraded, or removed in the anomaly detector without having to retrain other ADNNs. Having specialized ADNNs can reduce overall network complexity and increase detection accuracy, as compared to having a single large neural network to identify all anomaly types.

The figures and the following description illustrate specific exemplary embodiments. It will be appreciated that those skilled in the art will be able to devise various arrangements that, although not explicitly described or shown herein, embody the principles described herein and are included within the scope of the claims that follow this description. Furthermore, any examples described herein are intended to aid in understanding the principles of the disclosure and are to be construed as being without limitation. As a result, this disclosure is not limited to the specific embodiments or examples described below, but by the claims and their equivalents.

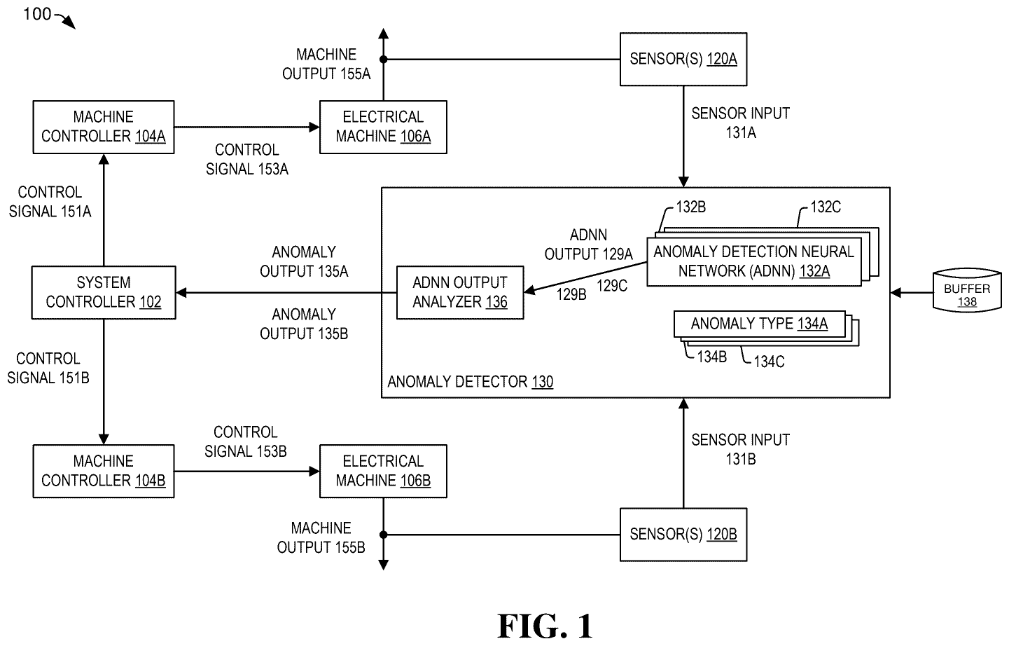

Particular implementations are described herein with reference to the drawings. In the description, common features are designated by common reference numbers throughout the drawings. In some drawings, multiple instances of a particular type of feature are used. Although these features are physically and/or logically distinct, the same reference number is used for each, and the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter. For example, referring to FIG. 1, multiple electrical machines are illustrated and associated with reference numbers 106A and 106B. When referring to a particular one of these electrical machines, such as the electrical machine 106A, the distinguishing letter “A” is used. However, when referring to any arbitrary one of these electrical machines or to these electrical machines as a group, the reference number 106 is used without a distinguishing letter.

As used herein, various terminology is used for the purpose of describing particular implementations only and is not intended to be limiting. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a system 100 including one or more sensors (“sensor(s)” 120A in FIG. 1) coupled to an electrical machine 106A, which indicates that in some implementations the system 100 includes a single sensor 120A coupled to the electrical machine 106A, and in other implementations the system 100 includes multiple sensors 120A coupled to the electrical machine 106A. For ease of reference herein, such features are generally introduced as “one or more” features, and are subsequently referred to in the singular or optional plural (as typically indicated by “(s)”) unless aspects related to multiple of the features are being described.

The terms “comprise,” “comprises,” and “comprising” are used interchangeably with “include,” “includes,” or “including.” Additionally, the term “wherein” is used interchangeably with the term “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

As used herein, “generating,” “calculating,” “using,” “selecting,” “accessing,” and “determining” are interchangeable unless context indicates otherwise. For example, “generating,” “calculating,” or “determining” a parameter (or a signal) can refer to actively generating, calculating, or determining the parameter (or the signal) or can refer to using, selecting, or accessing the parameter (or signal) that is already generated, such as by another component or device. As used herein, “coupled” can include “communicatively coupled,” “electrically coupled,” or “physically coupled,” and can also (or alternatively) include any combinations thereof. Two devices (or components) can be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled can be included in the same device or in different devices and can be connected via electronics, one or more connectors, or inductive coupling, as illustrative, non-limiting examples. In some implementations, two devices (or components) that are communicatively coupled, such as in electrical communication, can send and receive electrical signals (digital signals or analog signals) directly or indirectly, such as via one or more wires, buses, networks, etc. As used herein, “directly coupled” is used to describe two devices that are coupled (e.g., communicatively coupled, electrically coupled, or physically coupled) without intervening components.

As used herein, the term “machine learning” should be understood to have any of its usual and customary meanings within the fields of computer science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis.

For certain types of machine learning, the results that are generated include a data model (also referred to as a “machine-learning model” or simply a “model”). Typically, a model is generated using a first data set to facilitate analysis of a second data set. For example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both).

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows—a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so-called “transfer learning.” In transfer learning, a base model may be trained using a generic or typical data set, and the base model may be subsequently refined (e.g., re-trained or further trained) using a more specific data set.

Training a model based on a training data set involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value.

FIG. 1 depicts an example of a system 100 that is configured to perform sensor input based anomaly detection. The system 100 includes one or more electrical machines 106, such as an electrical machine 106A, an electrical machine 106B, one or more additional electrical machines, or a combination thereof. In some aspects, an electrical machine 106 includes a motor, a generator, or both.

The system 100 includes one or more machine controllers 104, such as a machine controller 104A, a machine controller 104B, one or more additional machine controllers, or a combination thereof. A particular machine controller 104 is configured to send a control signal 153 to a corresponding electrical machine 106 to control operation of the electrical machine 106. For example, a control signal 153 can be used to adjust voltage, current, frequency, power, or a combination thereof, of the electrical machine 106. In some implementations, a control signal 153 can be used to disable the electrical machine 106, enable the electrical machine 106, reduce power to the electrical machine 106, increase power to the electrical machine 106, adjust a power demand of the electrical machine 106, adjust a voltage of the electrical machine 106, adjust a frequency of the electrical machine 106, adjust an input current of the electrical machine 106, or a combination thereof. In some aspects, sending a control signal 153 to an electrical machine 106 can include sending the control signal 153 to a power distribution line coupled to the electrical machine 106.

In some implementations, a machine controller 104 is configured to implement specific control algorithms. For example, a machine controller 104, in accordance with a particular control algorithm, is configured to reduce power at a particular adjustment rate to prevent abrupt stopping of a corresponding electrical machine 106. In this example, the machine controller 104, to reduce power of the electrical machine 106 from a first power level to a second power level, sends multiple control signals 153 to gradually reduce power from the first power level to the second power level in compliance with the particular control algorithm. In a particular aspect, a control algorithm of a machine controller 104 is based on user input, default data, a configuration setting, properties of a corresponding electrical machine 106, or a combination thereof.

The system 100 includes a system controller 102 that is configured to send control signals 151 to the one or more machine controllers 104 to control operations of the one or more machine controllers 104, and thereby the one or more electrical machines 106. For example, the system controller 102 is configured to send a control signal 151 to a machine controller 104 indicating that power of a corresponding electrical machine 106 is to be reduced to the second power level. The machine controller 104, in response to receiving the control signal 151, sends one or more control signals 153 to the electrical machine 106 to reduce power from a first power level to the second power level.

In a particular implementation, a machine controller 104 includes one or more hardware components (e.g., one or more switches), and the system controller 102 sends a control signal 151 to the one or more hardware components. For example, a machine controller 104 can include one or more switches that couple a power distribution line to an electrical machine 106. In this example, the system controller 102 is configured to send a control signal 151 corresponding to a first control input (e.g., 1) to activate a switch of the machine controller 104 to enable current flow from the power distribution line to the electrical machine 106. The system controller 102 is configured to send a control signal 151 corresponding to a second control input (e.g., 0) to deactivate the switch of the machine controller 104 to disable current flow from the power distribution line to the electrical machine 106.

The system 100 includes an anomaly detector 130 and one or more sensors 120. The one or more sensors 120 are configured to monitor operation of one or more electrical machines 106, and the anomaly detector 130 is configured to generate, based on sensor input 131 from the sensor(s) 120, an anomaly output 135 indicating whether any anomalies are detected. To illustrate, the system 100 includes one or more sensors 120A configured to monitor a machine output 155A of the electrical machine 106A, one or more sensors 120B configured to monitor a machine output 155B of the electrical machine 106B, one or more additional sensors, or a combination thereof. For example, the one or more sensors 120A, based on the machine output 155A, generate sensor input 131A that corresponds to operation of the electrical machine 106A. In a particular aspect, the sensor input 131A indicates at least one of current, voltage, frequency, vibration, pressure, or temperature generated by the electrical machine 106A. As another example, the one or more sensors 120B, based on the machine output 155B, generate sensor input 131B that corresponds to operation of the electrical machine 106B. In some implementations, a single sensor can be used to monitor operations of multiple electrical machines 106. For example, the one or more sensors 120A can include a particular sensor that is shared with the one or more sensors 120B.

A sensor 120 can include at least one of a current sensor, a frequency sensor, a voltage sensor, a vibration sensor, a pressure sensor, or a temperature sensor. For example, a current sensor can include at least one of a shunt resistor, a hall effect sensor, a current transformer, an air-cored coil, a magnetoresistive current sensor, a fiber optic current sensor, or a clamp meter. In some implementations, a frequency sensor includes at least one of a tachometer generator, a hall effect sensor, an optical encoder, a proximity sensor, a resonant frequency sensor, a piezoelectric sensor, a digital frequency counter, or a phase-locked loop (PLL) based sensor. In a particular aspect, a voltage sensor includes at least one of a voltage transducer, a hall effect voltage sensor, an electro-optical voltage sensor, an analog voltage sensor, a digital voltage sensor, or an isolation amplifier. In some implementations, a pressure sensor includes at least one of a pressure transducer, a piezoelectric pressure sensor, a strain gauge pressure sensor, a capacitive pressure sensor, an inductive pressure sensor, a resistive pressure sensor, an optical pressure sensor, a micro-electro-mechanical systems (MEMS) pressure sensor, or a pressure switch. In an example, a temperature sensor includes at least one of a thermocouple, a resistance temperature detector (RTD), a thermistor, a semiconductor temperature sensor, an infrared (IR) temperature sensor, a temperature switch, or a digital temperature sensor. It should be understood that particular examples of sensors are illustrative and non-limiting, in other examples a sensor 120 can include any type of sensor.

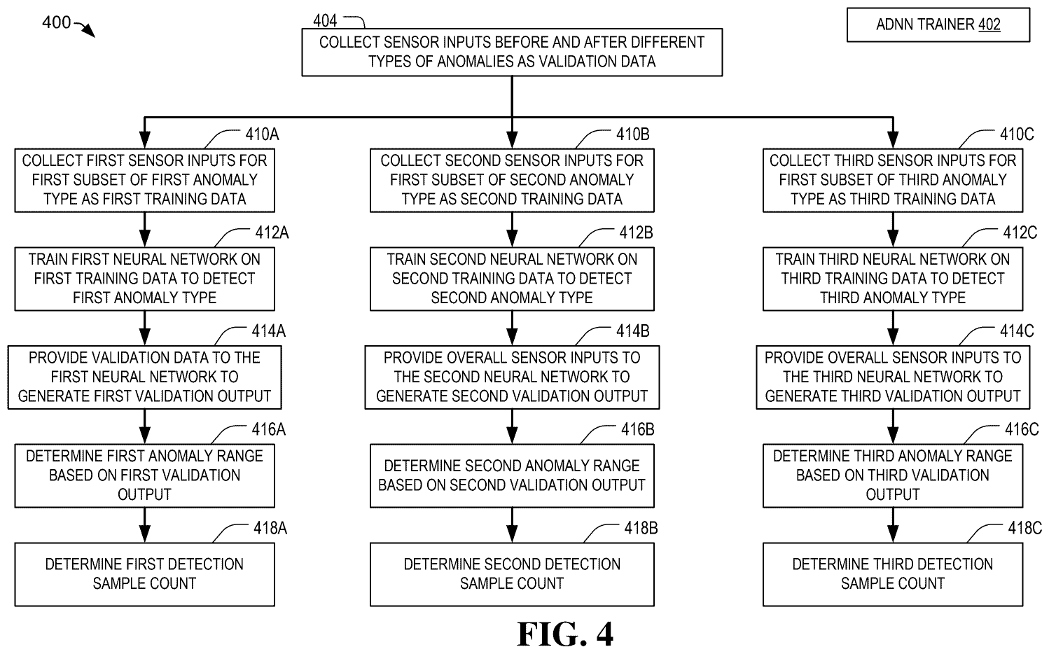

The anomaly detector 130 includes an ADNN output analyzer 136 coupled to one or more anomaly detection neural networks (ADNNs) 132, such as an ADNN 132A, ADNN 132B, ADNN 132C, one or more other ADNNs, or a combination thereof. A particular ADNN is trained to identify a corresponding anomaly type 134, as further described with reference to FIG. 4. For example, the ADNN 132A, the ADNN 132B, and the ADNN 132C are trained to identify an anomaly type 134A, an anomaly type 134B, and an anomaly type 134C, respectively. An anomaly type 134 can include a degradation type, a fault type, or both. For example, an anomaly type 134 can include a TT fault, a grounding fault, an open winding (OW) fault, phase unbalance (e.g., 3-phase unbalance), mechanical wear and tear (e.g., bearing failure, shaft misalignment, rotor imbalance, stator deformation, etc.), electrical insulation degradation (e.g., insulation breakdown, corona discharge, etc.), thermal degradation (e.g., overheating, freezing, thermal cycling, etc.), mechanical vibrations, shock loads, contamination (e.g., dust and debris, moisture and corrosion, etc.), electrical overstress (e.g., overvoltage and undervoltage, overfrequency, overcurrent, etc.), aging (e.g., material fatigue, chemical degradation, etc.), or a combination thereof. It should be understood that particular anomaly types are provided as illustrative non-limiting examples, in other examples an anomaly type 134 can include any anomaly type.

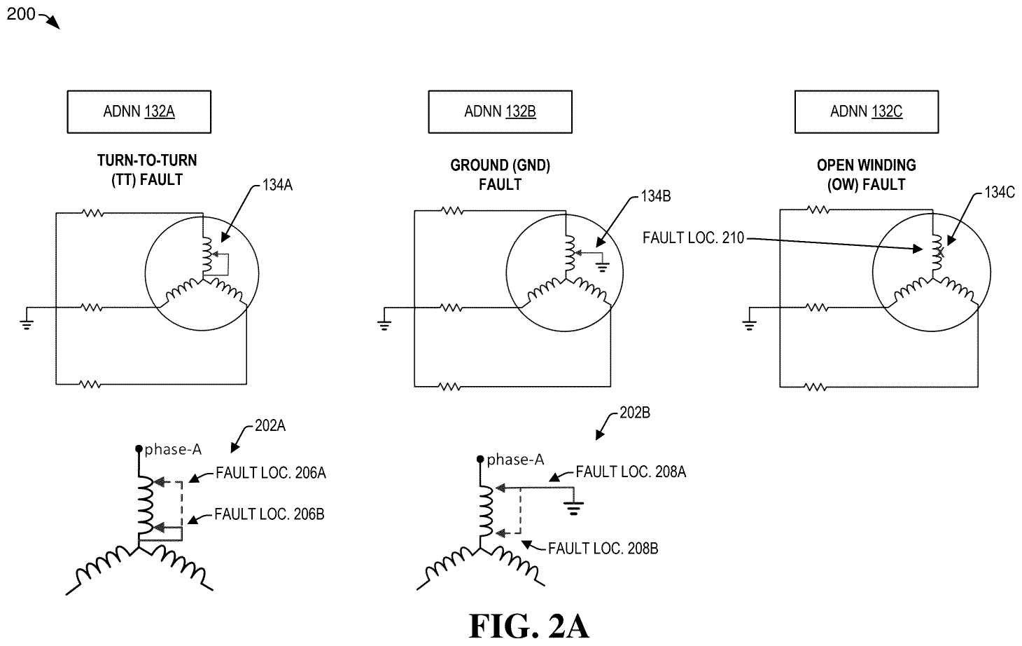

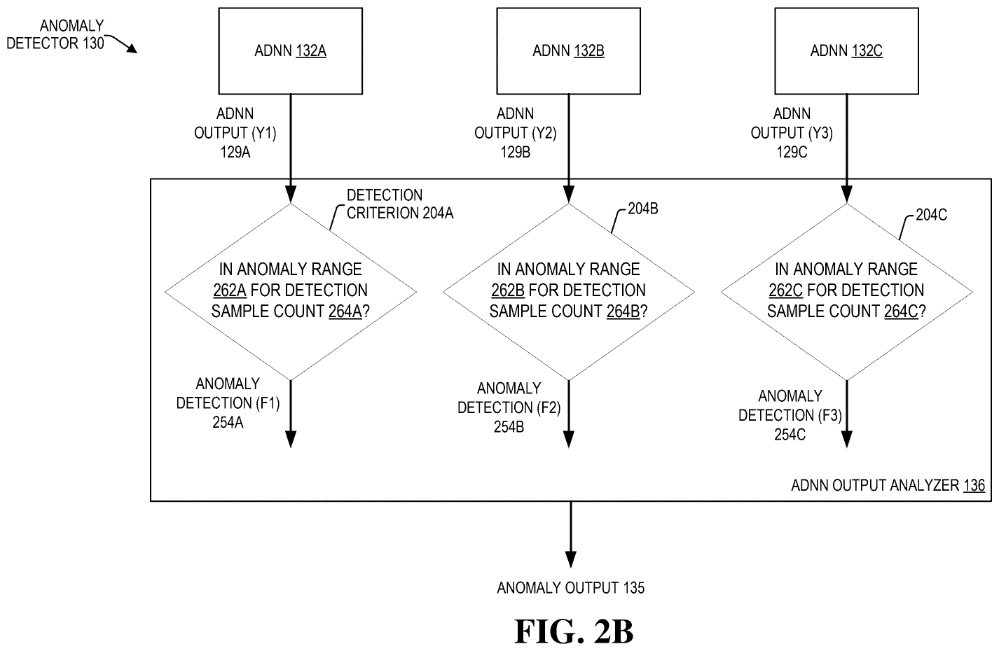

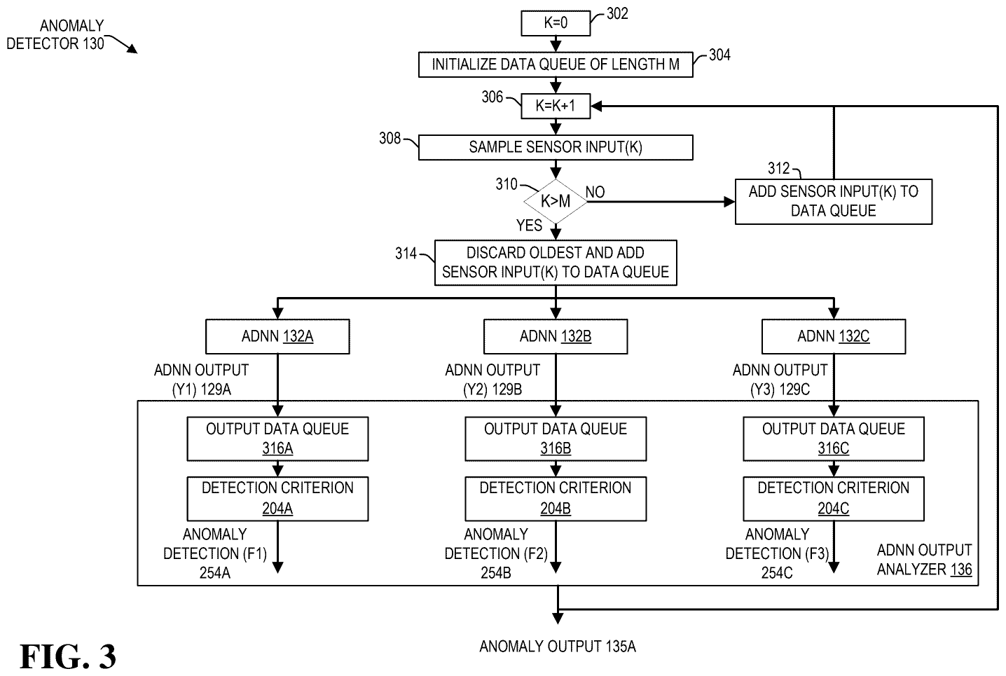

The ADNN output analyzer 136 is configured to process an ADNN output 129 of an ADNN 132 to determine whether a corresponding anomaly type 134 is detected, as further described with reference to FIGS. 2B and 3. For example, the ADNN output analyzer 136 is configured to, in response to determining that an ADNN output 129A of the ADNN 132A satisfies a detection criterion of the anomaly type 134A, determine that the anomaly type 134A is detected. As another example, the ADNN output analyzer 136 is configured to, in response to determining that an ADNN output 129B of the ADNN 132B satisfies a detection criterion of the anomaly type 134B, determine that the anomaly type 134B is detected. In another example, the ADNN output analyzer 136 is configured to, in response to determining that an ADNN output 129C of the ADNN 132C satisfies a detection criterion of the anomaly type 134C, determine that the anomaly type 134C is detected. The ADNN output analyzer 136 is configured to generate an anomaly output 135 indicating whether any of the one or more anomaly types 134 are detected and to provide the anomaly output 135 to the system controller 102. The system controller 102 is configured to generate a control signal 151 to a machine controller 104 to perform a remedial action related to an electrical machine 106 based on whether any of the one or more anomaly types 134 are detected.

The system controller 102, the one or more machine controllers 104, the one or more electrical machines 106, the one or more sensors 120, and the anomaly detector 130 are interconnected via one or more networks to enable data communications. For example, the system controller 102 is coupled to the one or more machine controllers 104 via one or more wireless networks, one or more wireline networks, or any combination thereof. Two or more of the system controller 102, the one or more machine controllers 104, the one or more electrical machines 106, the one or more sensors 120, or the anomaly detector 130 can be co-located or geographically distributed from each other.

During operation, the one or more electrical machines 106 generate machine outputs 155. For example, the electrical machine 106A generates a machine output 155A and the electrical machine 106B generates a machine output 155B. The one or more sensors 120, based on the machine outputs 155, provide sensor inputs 131 to the anomaly detector 130. For example, the one or more sensors 120A, based on the machine output 155A of the electrical machine 106A, provide a sensor input 131A to the anomaly detector 130. To illustrate, the sensor input 131A corresponds to a measurement (e.g., a sample) of the machine output 155A detected by the sensor 120A. As another example, the one or more sensors 120B, based on the machine output 155B of the electrical machine 106B, provide a sensor input 131B to the anomaly detector 130.

The anomaly detector 130 uses the ADNN(s) 132 to process sensor input 131 to generate ADNN output(s) 129, as further described with reference to FIGS. 2B-3. For example, the anomaly detector 130 uses the ADNN 132A, the ADNN 132B, and the ADNN 132C to process the sensor input 131A to generate an ADNN output 129A, an ADNN output 129B, and an ADNN output 129C, respectively.

In some implementations, the system 100 includes a memory buffer 138 coupled to the anomaly detector 130, and the anomaly detector 130 stores a most recent set of samples of sensor input 131 in the memory buffer 138. An ADNN 132 is configured to process the sensor input 131 using a sliding window of the most recent set of samples. For example, the anomaly detector 130 uses the ADNN 132A, the ADNN 132B, and the ADNN 132C to process a sliding window of the most recent set of samples of the sensor input 131A to generate the ADNN output 129A, the ADNN output 129B, and the ADNN output 129C, respectively, as further described with reference to FIG. 3.

The ADNN output analyzer 136 generates an anomaly output 135A indicating whether any of the one or more anomaly types 134 are detected for the electrical machine 106A, as further described with reference to FIGS. 2B-3. For example, the ADNN output analyzer 136 generates the anomaly output 135A based on determining whether the ADNN output 129A, the ADNN output 129B, and the ADNN output 129C satisfy a detection criterion of the anomaly type 134A, a detection criterion of the anomaly type 134B, and a detection criterion of the anomaly type 134C, respectively. To illustrate, the ADNN output analyzer 136, in response to determining that the ADNN output 129A satisfies the detection criterion of the anomaly type 134A, generates the anomaly output 135A indicating that the anomaly type 134A is detected at the electrical machine 106A. In another example, the ADNN output analyzer 136, in response to determining that the ADNN output 129B satisfies the detection criterion of the anomaly type 134B, generates the anomaly output 135A indicating that the anomaly type 134B is detected at the electrical machine 106A. Similarly, the anomaly detector 130 uses the ADNN 132A, the ADNN 132B, and the ADNN 132C to process the sensor input 131B, and the ADNN output analyzer 136 generates an anomaly output 135B indicating whether any of the one or more anomaly types 134 are detected at the electrical machine 106B.

The ADNN output analyzer 136 provides the anomaly output 135 to the system controller 102. For example, the ADNN output analyzer 136 provides the anomaly output 135A and the anomaly output 135B to the system controller 102. The system controller 102 generates one or more control signals 151 based on the anomaly output 135A, the anomaly output 135B, or both. For example, the system controller 102, in response to determining that the anomaly output 135A indicates that the anomaly type 134A is detected at the electrical machine 106A, provides a control signal 151A to the machine controller 104A of the electrical machine 106A, a control signal to one or more additional machine controllers of one or more additional electrical machines, or a combination thereof, to initiate a remedial action related to the electrical machine 106A. In a particular aspect, the remedial action includes disabling the electrical machine 106A, reducing power to the electrical machine 106A, adjusting power demand of the electrical machine 106A, adjusting a voltage of the electrical machine 106A, adjusting a frequency of the electrical machine 106A, adjusting an input current to the electrical machine 106A, enabling an alternate electrical machine (e.g., the electrical machine 106B), or a combination thereof.

In an example, the system controller 102 sends a control signal 151A to the machine controller 104A indicating that the electrical machine 106A is to be deactivated and sends a control signal 151B to the machine controller 104B indicating that the electrical machine 106B (e.g., an alternate electrical machine) is to be activated. In some implementations, the machine controller 104A, responsive to the control signal 151A, provides one or more control signals 153A to the electrical machine 106A. For example, the machine controller 104A provides one or more control signals 153A in compliance with one or more control algorithms. To illustrate, the one or more control signals 153A ramp down operations of the electrical machine 106A. In some implementations, the machine controller 104A includes one or more hardware components (e.g., one or more switches) coupled to the electrical machine 106A, and the control signal 151A adjusts the one or more hardware components to adjust operations of the electrical machine 106A.

In some implementations, the machine controller 104B, responsive to the control signal 151B, provides one or more control signals 153B to the electrical machine 106B. For example, the machine controller 104B provides one or more control signals 153B in compliance with one or more control algorithms. To illustrate, the one or more control signals 153B ramp up operations of the electrical machine 106B. In some implementations, the machine controller 104B includes one or more hardware components (e.g., one or more switches) coupled to the electrical machine 106B, and the control signal 151B adjusts the one or more hardware components to adjust operations of the electrical machine 106B. In a particular aspect, the electrical machine 106B is an alternative to (e.g., a replacement or backup of) the electrical machine 106A.

In some examples, the anomaly output 135A includes a log entry, an alert, or both, to initiate a future remedial action based on whether at least one of the anomaly types 134 is detected. In some examples, the system controller 102, in response to receiving the anomaly output 135A, generates a log entry, an alert, or both, to initiate a future remedial action based on whether the anomaly output 135A indicates that at least one of the anomaly types 134 is detected.

A technical advantage of the system 100 thus includes detection of an electrical machine 106 experiencing anomaly events of an anomaly type 134 in real-time without taking the electrical machine 106 off-line. In some aspects, an anomaly type 134 can be detected early prior to the electrical machine 106 becoming inoperable. In some implementations, an ADNN 132 is trained to identify complex relations of sensor input 131 to identify an anomaly type 134. An ADNN 132 can be added, upgraded, or removed in the anomaly detector 130 without having to retrain other ADNNs 132. Having specialized ADNNs 132 can reduce overall network complexity and increase detection accuracy, as compared to having a single large neural network to identify all anomaly types.

Although the system controller 102, the one or more machine controllers 104, the one or more electrical machines 106, the one or more sensors 120, the anomaly detector 130, and the memory buffer 138 are depicted as separate components, in other implementations the described functionality of two or more of the system controller 102, the one or more machine controllers 104, the one or more electrical machines 106, the one or more sensors 120, the anomaly detector 130, and the memory buffer 138 can be performed by a single component. In some implementations, each of the system controller 102, the one or more machine controllers 104, the one or more electrical machines 106, the one or more sensors 120, the anomaly detector 130, and the memory buffer 138 can be represented in hardware, such as via an application-specific integrated circuit (ASIC) or a field-programmable gate array (FPGA), or the operations described with reference to the elements may be performed by a processor executing computer-readable instructions.

Although FIG. 1 illustrates particular examples for clarity of explanation, such examples are not to be considered as limitations. For example, although the system 100 is illustrated as including two electrical machines 106, in other examples the system 100 includes a single electrical machine 106 or more than two electrical machines 106.

Referring to FIG. 2A, a diagram 200 is shown of an illustrative example of anomaly types 134 detectable by the anomaly detector 130 of the system 100 of FIG. 1. The ADNN 132A, the ADNN 132B, and the ADNN 132C are trained to identify anomaly events of the anomaly type 134A, the anomaly type 134B, and the anomaly type 134C, respectively.

In a particular aspect, the anomaly type 134A corresponds to a TT fault. In a diagram 202A, an example is shown of a TT fault at a fault location 206A relative to a phase terminal (e.g., phase A terminal) of an electrical machine 106. The fault location 206A corresponds to a short occurring at 1% of turns from the phase terminal, and a remaining portion (e.g., 99%) of the turns are shorted. In a particular aspect, a TT fault at the fault location 206A (e.g., 1%) may be referred to as 99% coil shorted. As another example, a TT fault is shown at a fault location 206B (e.g., 99% of turns from the phase terminal) that corresponds to a remaining portion (e.g., 1%) of the turns from the phase terminal being shorted. In a particular aspect, a TT fault at the fault location 206B (e.g., 99%) may be referred to as 1% coil shorted.

In a particular aspect, the anomaly type 134B corresponds to a grounding (GND) fault. In a diagram 202B, an example is shown of a GND fault at a fault location 208A (e.g., 1%) relative to a phase terminal (e.g., phase A terminal) of an electrical machine 106. In a particular aspect, a GND fault at the fault location 208A (e.g., 1% of turns from the phase terminal) may be referred to as a GND fault located at 1% coil. As another example, a GND fault is shown at a fault location 208B (e.g., 99% of turns from the phase terminal). In a particular aspect, a GND fault at the fault location 208B (e.g., 99%) may be referred to as a GND fault located at 99% coil.

In a particular aspect, the anomaly type 134C corresponds to an OW fault. An example is shown of an OW fault at a fault location 210 relative to a phase terminal (e.g., phase A terminal) of an electrical machine 106. It should be understood that particular examples of anomaly types 134 and particular fault locations are provided as illustrative non-limiting examples; in other examples the anomaly detector 130 is configured to detect anomaly types corresponding to other fault locations, other anomaly types, or a combination thereof.

Referring to FIG. 2B, a diagram is shown of an illustrative implementation of the anomaly detector 130 of the system 100 of FIG. 1. The ADNN output analyzer 136 is configured to receive ADNN output 129 from an ADNN 132 trained to detect an anomaly type 134 and to generate an anomaly output 135 based on determining whether the ADNN output 129 satisfies a detection criterion 204 of the anomaly type 134.

In some implementations, the detection criterion 204 is based on an anomaly range 262 and a detection sample count 264. In a particular aspect, the anomaly range 262 and the detection sample count 264 are determined during training of an ADNN 132, as further described with reference to FIG. 4. For example, a detection criterion 204A of an anomaly type 134A is based on an anomaly range 262A and a detection sample count 264A. As another example, a detection criterion 204B of an anomaly type 134B is based on an anomaly range 262B and a detection sample count 264B. As yet another example, a detection criterion 204C of an anomaly type 134C is based on an anomaly range 262C and a detection sample count 264C.

The one or more ADNNs 132 process the sensor input 131A from the one or more sensors 120A configured to monitor the machine output 155A of the electrical machine 106A. In a particular implementation, the most recent samples of the sensor input 131A are stored in the memory buffer 138 (e.g., an input data queue). The anomaly detector 130 uses the one or more ADNNs 132 to process a sliding window (e.g., M samples, where M is a positive integer) of the most recent samples. For example, the ADNN 132A (trained to detect the anomaly type 134A) processes the sensor input 131A (e.g., M most recent samples) to generate an ADNN output 129A. As another example, the ADNN 132B (trained to detect the anomaly type 134B) processes the sensor input 131A (e.g., the M most recent samples) to generate an ADNN output 129B. As yet another example, the ADNN 132C (trained to detect the anomaly type 134C) processes the sensor input 131A (e.g., the M most recent samples) to generate an ADNN output 129C.

The ADNN output analyzer 136 determines whether the ADNN output 129A, the ADNN output 129B, and the ADNN output 129C satisfy the detection criterion 204A, the detection criterion 204B, and the detection criterion 204C, respectively. In some implementations, a set of most recent values of the ADNN output 129A is stored in the memory buffer 138 (e.g., an output data queue) of FIG. 1. In an example, the ADNN output analyzer 136, in response to determining that each of at least the detection sample count 264A (e.g., N output values, where N is a positive integer) of the most recent values of the ADNN output 129A is within the anomaly range 262A, determines, at a first time, that the anomaly type 134A is detected at the electrical machine 106A at a first detection time. The first detection time is based on the first time, a sample time associated with the sensor input 131A (e.g., one or more of the M most recent samples), a time associated with the ADNN output 129A (e.g., one or more of the N output values), or a combination thereof. The ADNN output analyzer 136, in response to determining that the anomaly type 134A is detected, generates the anomaly output 135 indicating that the anomaly type 134A is detected at the electrical machine 106A at the first detection time.

In another example, the ADNN output analyzer 136, in response to determining that each of at least the detection sample count 264B (e.g., Q output values, where Q is a positive integer) of the most recent values of the ADNN output 129B is within the anomaly range 262B, determines, at a second time, that the anomaly type 134B is detected at the electrical machine 106A at a second detection time. The second detection time is based on the second time, the sample time associated with the sensor input 131A (e.g., one or more of the M most recent samples), a time associated with the ADNN output 129B (e.g., one or more of the Q output values), or a combination thereof. The ADNN output analyzer 136, in response to determining that the anomaly type 134B is detected, generates the anomaly output 135 indicating that the anomaly type 134B is detected at the electrical machine 106A at the second detection time. Similarly, the ADNN output analyzer 136, in response to determining that the anomaly type 134C is detected, generates the anomaly output 135 indicating that the anomaly type 134C is detected at the electrical machine 106A at a third detection time.

A technical advantage of the detection criterion 204 based on a detection sample count 264 includes improved detection accuracy. For example, in some aspects, the ADNN output 129A fluctuates and can transiently enter the anomaly range 262A even while the electrical machine 106A is not experiencing the anomaly type 134A. Having the detection criterion 204A based on the detection sample count 264A enables detection of the anomaly type 134A when the ADNN output 129A persistently stays within the anomaly range 262A for at least the detection sample count 264A.

Referring to FIG. 3, a diagram is shown of an illustrative aspect of operations of the anomaly detector 130 of the system 100 of FIG. 1. The anomaly detector 130 initializes a sample counter (K) to an initial value (e.g., 0), at 302.

The anomaly detector 130 initializes a data queue (e.g., an input data queue), at 304. For example, the anomaly detector 130 allocates memory from the memory buffer 138 to the input data queue so that the input data queue can be used to store at least up to a particular count (M) of samples of sensor input 131A. In a particular implementation, the anomaly detector 130 also initializes one or more output data queues 316. For example, the anomaly detector 130 initializes an output data queue 316A to store up to a particular count (N) of the most recent output values of the ADNN output 129A of the ADNN 132A. As another example, the anomaly detector 130 initializes an output data queue 316B to store up to a particular count (Q) of the most recent output values of the ADNN output 129B of the ADNN 132B. As yet another example, the anomaly detector 130 initializes an output data queue 316C to store up to a particular count (R) of the most recent output values of the ADNN output 129C of the ADNN 132C.

The anomaly detector 130 increments the sample counter (K) by 1, at 306. The anomaly detector 130 samples the sensor input 131A, at 308. For example, the anomaly detector 130 obtains a sample (e.g., a Kth sample) of the sensor input 131A from the one or more sensors 120A.

The anomaly detector 130 determines whether at least the particular count (M) of samples of the sensor input 131A are stored in the input data queue, at 310. The anomaly detector 130, in response to determining that fewer than the particular count (M) of samples of the sensor input 131A are stored in the input data queue, at 310, adds the sample of the sensor input 131A to the input data queue, at 312, and proceeds to 306. Alternatively, the anomaly detector 130, in response to determining that at least the particular count (M) of samples of the sensor input 131A are stored in the input data queue, at 310, discards an oldest sample from the input data queue and adds the sample (e.g., the Kth sample) of the sensor input 131A to the input data queue, at 314.

The anomaly detector 130 uses the one or more ADNNs 132 to process the sensor input 131A (e.g., the M samples stored in the input data queue). For example, the ADNN 132A processes the sensor input 131A (e.g., the M stored samples) to generate an ADNN output 129A (Y1). In a particular aspect, the anomaly detector 130, in response to determining that the output data queue 316A of the ADNN 132A includes at least a particular count (N) of values of the ADNN output 129A, discards the oldest value stored in the output data queue 316A. The anomaly detector 130 adds the value of the ADNN output 129A (Y1) to the output data queue 316A of the ADNN 132A.

As another example, the ADNN 132B processes the sensor input 131A (e.g., the M stored samples) to generate an ADNN output 129B (Y2). In a particular aspect, the anomaly detector 130, in response to determining that the output data queue 316B of the ADNN 132B includes at least a particular count (Q) of values of the ADNN output 129B, discards the oldest value stored in the output data queue 316B. The anomaly detector 130 adds the value of the ADNN output 129B (Y2) to the output data queue 316B of the ADNN 132B.

As yet another example, the ADNN 132C processes the sensor input 131A (e.g., the M stored samples) to generate an ADNN output 129C (Y3). In a particular aspect, the anomaly detector 130, in response to determining that the output data queue 316C of the ADNN 132C includes at least a particular count (R) of values of the ADNN output 129C, discards the oldest value stored in the output data queue 316C. The anomaly detector 130 stores the value of the ADNN output 129C (Y3) in the output data queue 316C of the ADNN 132C.

The ADNN output analyzer 136 generates an anomaly detection output 254 indicating whether a detection criterion 204 of an anomaly type 134 is satisfied. For example, the ADNN output analyzer 136 generates an anomaly detection output 254A (F1) indicating whether the detection criterion 204A of the anomaly type 134A is satisfied, as described with reference to FIG. 2B. In a particular implementation, the ADNN output analyzer 136, in response to determining that each of at least a detection sample count 264A (e.g., N=25) of the most recent output values included in the output data queue 316A are within the anomaly range 262A, determines that the detection criterion 204A is satisfied. Alternatively, the ADNN output analyzer 136, in response to determining that fewer than the detection sample count 264A of output values are stored in the output data queue 316A or that at least one of the detection sample count 264A (e.g., N=25) of the most recent output values included in the output data queue 316A is not within the anomaly range 262A, determines that the detection criterion 204A is not satisfied.

Similarly, the ADNN output analyzer 136 generates an anomaly detection output 254B (F2) indicating whether the detection criterion 204B of the anomaly type 134B is satisfied. In yet another example, the ADNN output analyzer 136 generates an anomaly detection output 254C (F3) indicating whether the detection criterion 204C of the anomaly type 134C is satisfied.

The ADNN output analyzer 136 generates an anomaly output 135A based on the anomaly detection output 254. For example, the ADNN output analyzer 136, in response to determining that the detection criterion 204A is satisfied, generates the anomaly output 135A indicating that the anomaly type 134A is detected at the electrical machine 106A at a first detection time, as described with reference to FIG. 2B. Alternatively, the ADNN output analyzer 136, in response to determining that the detection criterion 204A is not satisfied, generates the anomaly output 135A indicating that the anomaly type 134A is not detected at the electrical machine 106A. In another example, the ADNN output analyzer 136, in response to determining that the detection criterion 204B is satisfied, generates the anomaly output 135A indicating that the anomaly type 134B is detected at the electrical machine 106A at a second detection time. Alternatively, the ADNN output analyzer 136, in response to determining that the detection criterion 204B is not satisfied, generates the anomaly output 135A indicating that the anomaly type 134B is not detected at the electrical machine 106A. In yet another example, the ADNN output analyzer 136, in response to determining that the detection criterion 204C is satisfied, generates the anomaly output 135A indicating that the anomaly type 134C is detected at the electrical machine 106A at a third detection time. Alternatively, the ADNN output analyzer 136, in response to determining that the detection criterion 204C is not satisfied, generates the anomaly output 135A indicating that the anomaly type 134C is not detected at the electrical machine 106A. The ADNN output analyzer 136 proceeds to 306.

Referring to FIG. 4, a diagram is shown of an illustrative aspect of operations 400 of an ADNN trainer 402 that is configured to train the anomaly detector 130 of the system 100 of FIG. 1. In a particular aspect, the system 100 of FIG. 1 includes the ADNN trainer 402.

The ADNN trainer 402 collects sensor inputs before and after different types of anomalies as validation data, at 404. For example, the validation data includes sets of sensor input 131A when an electrical machine 106A is not experiencing anomaly events associated with any anomalies, as well as sets of sensor input 131A when the electrical machine 106A is experiencing one or more anomaly events of the one or more anomaly types 134.

The ADNN trainer 402 collects sets of sensor input as training data. For example, the ADNN trainer 402 collects first sensor inputs for a first subset of a first anomaly type as first training data, at 410A, second sensor inputs for a first subset of a second anomaly type as second training data, at 410B, and third sensor inputs for a first subset of a third anomaly type as third training data, at 410C. To illustrate, a user causes the electrical machine 106A to experience anomaly events of a first subset (e.g., 95%, 50%, and 5% coil short circuits) of the anomaly type 134A (e.g., TT faults) while the ADNN trainer 402 collects the sensor input 131A as first training data.

Similarly, a user causes the electrical machine 106A to experience anomaly events of a first subset of the anomaly type 134B (e.g., grounding faults) while the ADNN trainer 402 collects the sensor input 131A as second training data. In yet another example, a user causes the electrical machine 106A to experience anomaly events of a first subset of the anomaly type 134C (e.g., OW faults) while the ADNN trainer 402 collects the sensor input 131A as third training data.

The ADNN trainer 402 uses the training data to train the one or more ADNNs 132 to detect the one or more anomaly types 134. For example, the ADNN trainer 402 trains a first neural network (e.g., the ADNN 132A) on the first training data to the detect the anomaly type 134A, at 412A, trains a second neural network (e.g., the ADNN 132B) on the second training data to the detect the anomaly type 134B, at 412B, and trains a third neural network (e.g., the ADNN 132C) on the third training data to the detect the anomaly type 134C, at 412C.

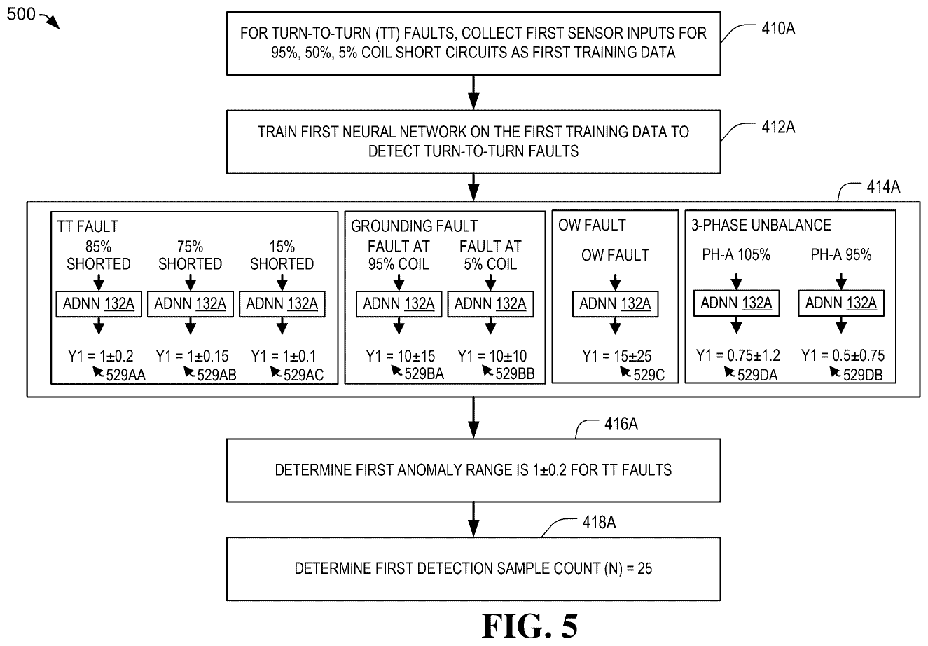

The ADNN trainer 402 uses the validation data to validate the trained ADNNs 132. For example, the ADNN trainer 402 uses the ADNN 132A to process the validation data to generate ADNN output 129A as first validation output, at 414A, determines a first anomaly range (e.g., the anomaly range 262A) based on the first validation output, at 416A, and determines a first detection sample count (e.g., the detection sample count 264A), at 418A, as further described with reference to FIG. 5. The ADNN trainer 402 generates the detection criterion 204A of the anomaly type 134A based on the anomaly range 262A and the detection sample count 264A. In an example, the ADNN trainer 402 outputs the ADNN 132A and designates the ADNN 132A as trained to detect the anomaly type 134A based on the detection criterion 204A.

Similarly, the ADNN trainer 402 uses the ADNN 132B to process the validation data to generate ADNN output 129B as second validation output, at 414B, determines a second anomaly range (e.g., the anomaly range 262B) based on the second validation output, at 416B, and determines a second detection sample count (e.g., the detection sample count 264B), at 418B. The ADNN trainer 402 generates the detection criterion 204B of the anomaly type 134B based on the anomaly range 262B and the detection sample count 264B. In an example, the ADNN trainer 402 outputs the ADNN 132B and designates the ADNN 132B as trained to detect the anomaly type 134B based on the detection criterion 204B.

In yet another example, the ADNN trainer 402 uses the ADNN 132C to process the validation data to generate ADNN output 129C as third validation output, at 414C, determines a third anomaly range (e.g., the anomaly range 262C) based on the third validation output, at 416C, and determines a third detection sample count (e.g., the detection sample count 264C), at 418C. The ADNN trainer 402 generates the detection criterion 204C of the anomaly type 134C based on the anomaly range 262C and the detection sample count 264C. In an example, the ADNN trainer 402 outputs the ADNN 132C and designates the ADNN 132C as trained to detect the anomaly type 134C based on the detection criterion 204C.

In some aspects, an ADNN 132 is trained using a first electrical machine 106A and is deployed to detect anomalies at a second electrical machine 106A. In other aspects, an ADNN 132 is deployed to detect anomalies of the same electrical machine 106A that is used to train the ADNN 132.

It should be understood that the one or more ADNNs 132 being trained concurrently by the ADNN trainer 402 is provided as an illustrative example, in other examples an ADNN 132 can be trained separately from training one or more other ADNNs 132, trained by another ADNN trainer than used to train one or more other ADNNs 132, or a combination thereof.

Referring to FIG. 5, a diagram is shown of an illustrative aspect of operations 500 of the ADNN trainer 402 of FIG. 4. For example, the operations 500 correspond to an example of training and validation of the ADNN 132A to detect the anomaly type 134A (e.g., TT faults).

The ADNN trainer 402 collects sensor input 131A as first training data while an electrical machine 106A experiences anomaly events of a first subset (e.g., 95%, 50%, and 5% coil short circuits) of the anomaly type 134A (e.g., TT faults), as described with reference to 410 of FIG. 4.

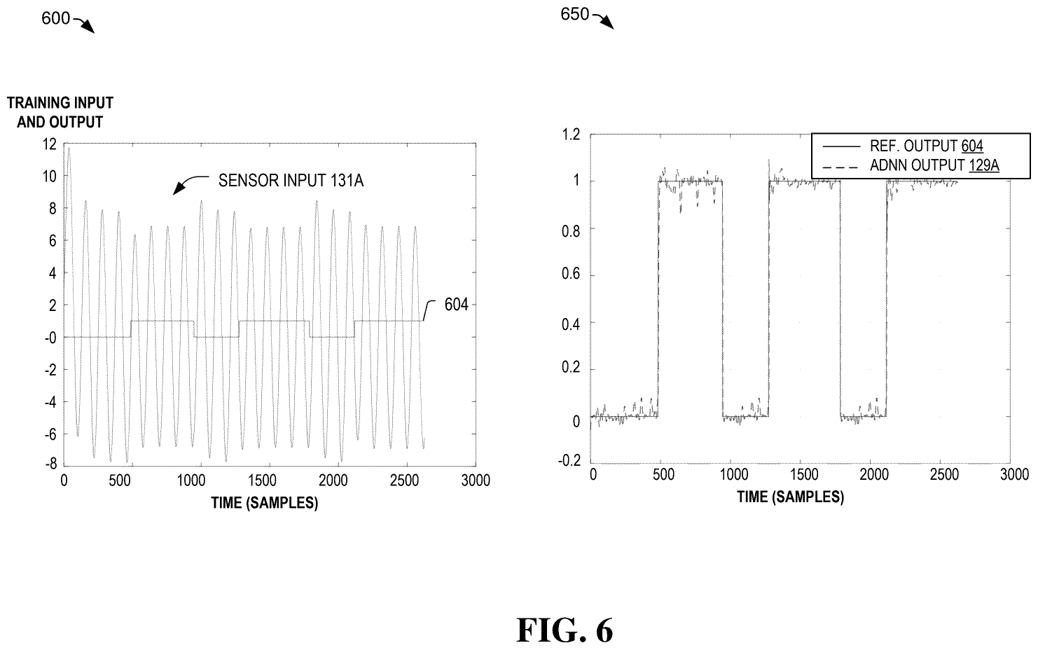

The ADNN trainer 402 trains a first neural network (e.g., the ADNN 132A) on the first training data to detect the anomaly type 134A (e.g., TT faults), as described with reference to 412A of FIG. 4. For example, as further described with reference to FIG. 6, the first training data includes one or more anomalous sets of the sensor input 131A that correspond to the electrical machine 106A experiencing any of the first subset (e.g., 95%, 50%, and 5% coil short circuits) of the anomaly type 134A (e.g., TT faults). The first training data also includes one or more non-anomalous sets of the sensor input 131A that correspond to the electrical machine 106A not experiencing any anomaly events of the one or more anomaly types 134. An anomalous set is associated with a first value (e.g., 1) of a reference output, and a non-anomalous set is associated with a second value (e.g., 0) of the reference output. The ADNN trainer 402 trains the ADNN 132A to reduce an error metric that is based on a comparison of the reference output and the ADNN output 129A of the ADNN 132A. For example, the error metric is based on a difference between the ADNN output 129A from processing sets of the first training data and the corresponding reference output.

The ADNN trainer 402 uses the ADNN 132A to process validation data to generate ADNN output 129A as first validation output, as described with reference to 414A of FIG. 4. For example, the validation data includes one or more first sets (e.g., 85% coil short circuits), one or more second sets (e.g., 75% coil short circuits), and one or more third sets (e.g., 15% coil short circuits) of the sensor input 131A that correspond to the electrical machine 106A experiencing the anomaly type 134A (e.g., TT faults). In a particular aspect, the validation data includes the sensor input 131A corresponding to a second subset (e.g., 85%, 75%, and 15% coil short circuits) of the anomaly type 134A (e.g., TT faults) that is distinct from the first subset (e.g., 95%, 50%, and 5% coil short circuits) of the anomaly type 134A included in the first training data.

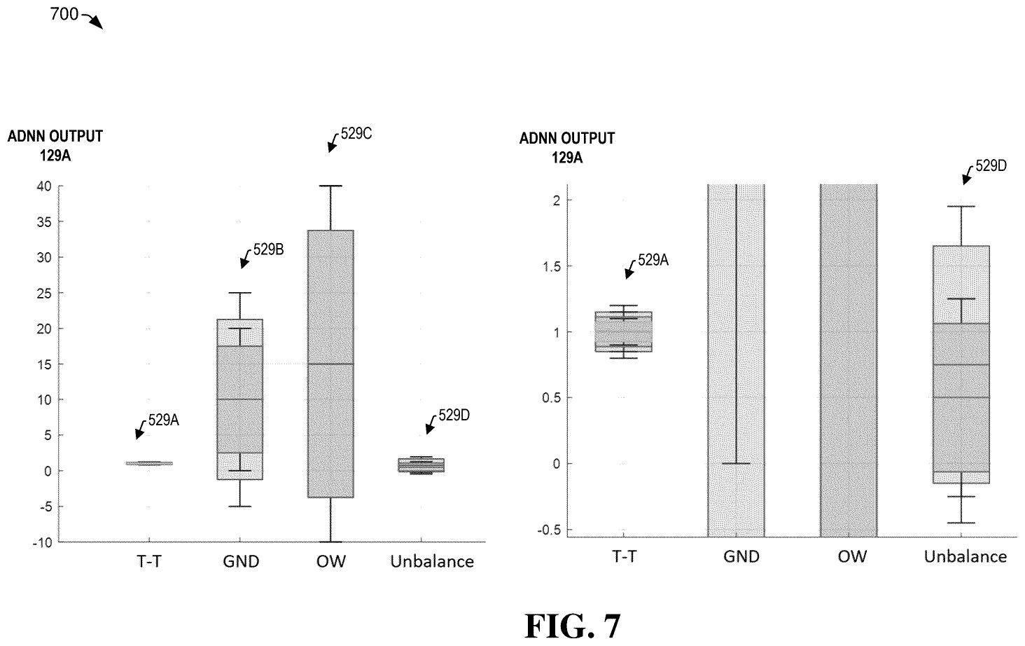

The ADNN trainer 402 uses the ADNN 132A to process the first sets (e.g., 85% coil short circuits) of the sensor input 131A to generate output values 529AA (e.g., 1±0.2) of the ADNN output 129A, as further described with reference to FIG. 7. The ADNN trainer 402 uses the ADNN 132A to process the second sets (e.g., 75% coil short circuits) of the sensor input 131A to generate output values 529AB (e.g., 1±0.15) of the ADNN output 129A. The ADNN trainer 402 uses the ADNN 132A to process the third sets (e.g., 15% coil short circuits) of the sensor input 131A to generate output values 529AC (e.g., 1±0.1) of the ADNN output 129A.

In a particular aspect, the validation data also includes one or more first sets (e.g., fault at 95% coil) and one or more second sets (e.g., fault at 5% coil) of the sensor input 131A that correspond to the electrical machine 106A experiencing the anomaly type 134B (e.g., grounding faults). The ADNN trainer 402 uses the ADNN 132A to process the first sets (e.g., fault at 95% coil) of the sensor input 131A to generate output values 529BA (e.g., 10±15) of the ADNN output 129A. The ADNN trainer 402 uses the ADNN 132A to process the second sets (e.g., fault at 5% coil) of the sensor input 131A to generate output values 529BB (e.g., 10±10) of the ADNN output 129A.

In a particular aspect, the validation data includes one or more sets of the sensor input 131A that correspond to the electrical machine 106A experiencing the anomaly type 134C (e.g., OW faults). The ADNN trainer 402 uses the ADNN 132A to process the sets (e.g., OW faults) of the sensor input 131A to generate output values 529C (e.g., 15±25) of the ADNN output 129A.

In a particular aspect, the validation data also includes one or more first sets (e.g., phase-A at 105%) and one or more second sets (e.g., phase-A at 95%) of the sensor input 131A that correspond to the electrical machine 106A experiencing another anomaly type (e.g., phase unbalance). The ADNN trainer 402 uses the ADNN 132A to process the first sets (e.g., phase-A at 105%) of the sensor input 131A to generate output values 529DA (e.g., 0.75±1.2) of the ADNN output 129A. The ADNN trainer 402 uses the ADNN 132A to process the second sets (e.g., phase-A at 95%) of the sensor input 131A to generate output values 529DB (e.g., 0.5±0.75) of the ADNN output 129A.

The ADNN trainer 402 determines the anomaly range 262A based on the first validation output, as described with reference to 416A of FIG. 4. For example, the ADNN trainer 402 determines the anomaly range 262A based on the output values 529. In a particular implementation, the ADNN trainer 402 determines the anomaly range 262A based on the output values 529A (e.g., 1±0.2, 1±0.15, and 1±0.1) associated with the anomaly type 134A (e.g., TT faults). In a particular aspect, the anomaly range 262A is a range (e.g., 1±0.2) that includes all of the output values 529A (e.g., 1±0.2, 1±0.15, and 1±0.1).

The ADNN trainer 402 determines the detection sample count 264A, as described with reference to 418A of FIG. 4. For example, the ADNN trainer 402 determines that the output values 529BA, the output values 529BB, the output values 529C, the output values 529DA, and the output values 529DB include a first count, a second count, a third count, a fourth count, and a fifth count, respectively of consecutive output values within the anomaly range 262A. The ADNN trainer 402 determines the detection sample count 264A that is greater than each of the first count, the second count, the third count, the fourth count, and the fifth count. In an example, the ADNN trainer 402 identifies a highest count among the first count, the second count, the third count, the fourth count, and the fifth count, and determines the detection sample count 264A (e.g., N=25) based on a sum of the highest count (e.g., 20) and a buffer count (e.g., 5). In a particular aspect, the buffer count is based on a user input, a configuration setting, default data, or a combination thereof.

Referring to FIG. 6, a graph 600 depicts an example of sensor input 131A and reference output 604, and a graph 650 depicts an example of ADNN output 129A and the reference output 604.

During training, the ADNN trainer 402 uses the ADNN 132A to process the sensor input 131A, as described with reference to FIGS. 4 and 5. The ADNN trainer 402 generates the reference output 604 to have a first value (e.g., 1) when the sensor input 131A corresponds to the electrical machine 106A experiencing an anomalous event of the anomaly type 134A (e.g., TT faults), and generates the reference output 604 to have a second value (e.g., 0) when the sensor input 131A corresponds to the electrical machine 106A not experiencing any anomalous event of the anomaly type 134A.

The ADNN trainer 402 trains the ADNN 132A to reduce an error metric that is based on the reference output 604 and the ADNN output 129A. For example, the error metric is based on a difference between the reference output 604 and the ADNN output 129A.

Referring to FIG. 7, a graph 700 depicts an example of output values 529 of ADNN output 129A of an ADNN 132A for sensor input 131A corresponding to various anomaly types. The graph 750 depicts a zoomed-in view of the output values 529 of the ADNN output 129A.

During validation, the ADNN trainer 402 uses the ADNN 132A to process validation data (e.g., the sensor input 131A) corresponding to various anomalies to generate the ADNN output 129A, as described with reference to FIG. 5. The graph 700 includes the output values 529A (e.g., 1±0.2, 1±0.15, and 1±0.1), the output values 529B (e.g., 10±10 and 10±15), the output values 529C (e.g., 15±25), and the output values 529D (e.g., 0.75±1.2 and 0.5±0.75) of the ADNN output 129A.

In the example shown in FIG. 7, the ADNN output 129A can enter the anomaly range 262A (e.g., 1±0.2) even while the electrical machine 106A is not experiencing the anomaly type 134A. Having the detection criterion 204A based on the detection sample count 264A enables detection of the anomaly type 134A when the ADNN output 129A persistently stays within the anomaly range 262A for at least the detection sample count 264A, as described with reference to FIGS. 2B and 3.

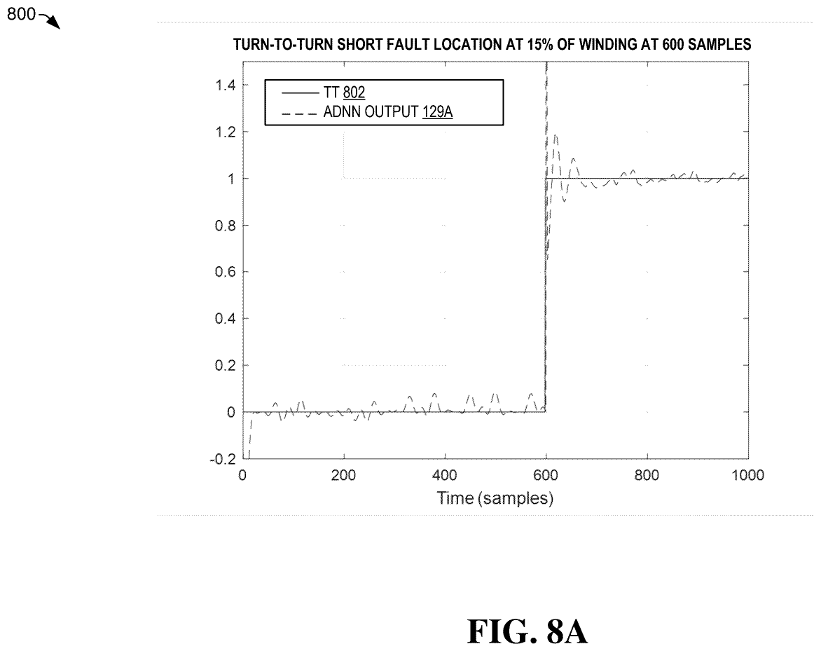

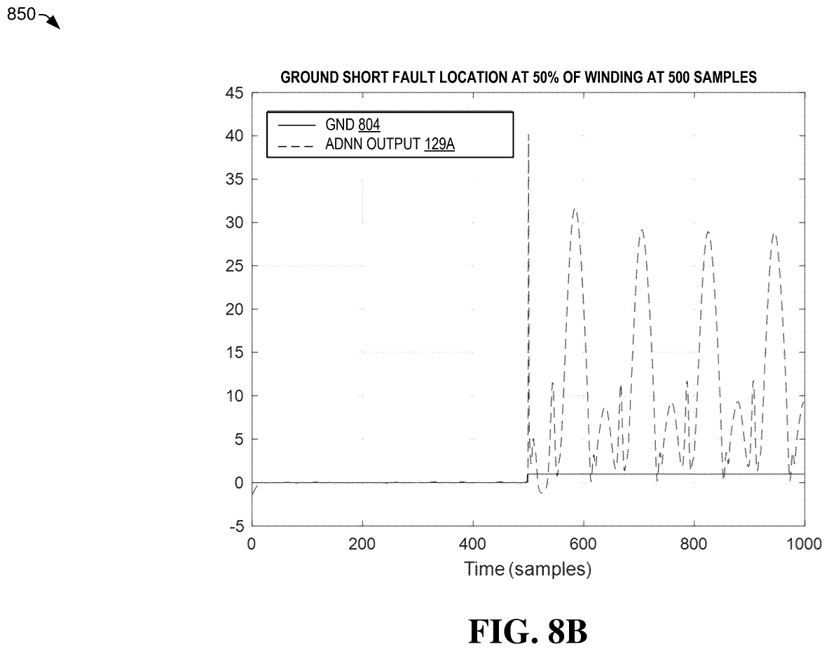

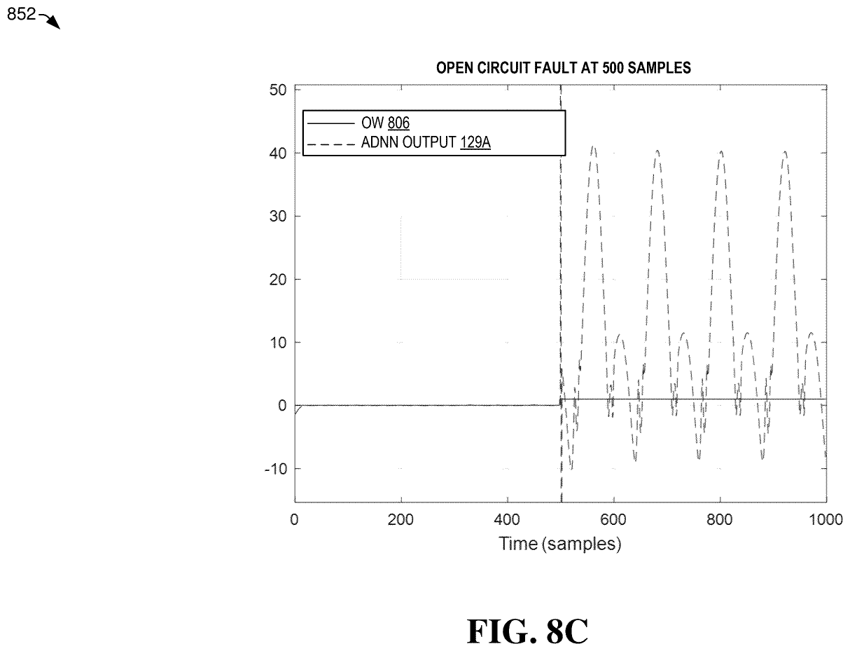

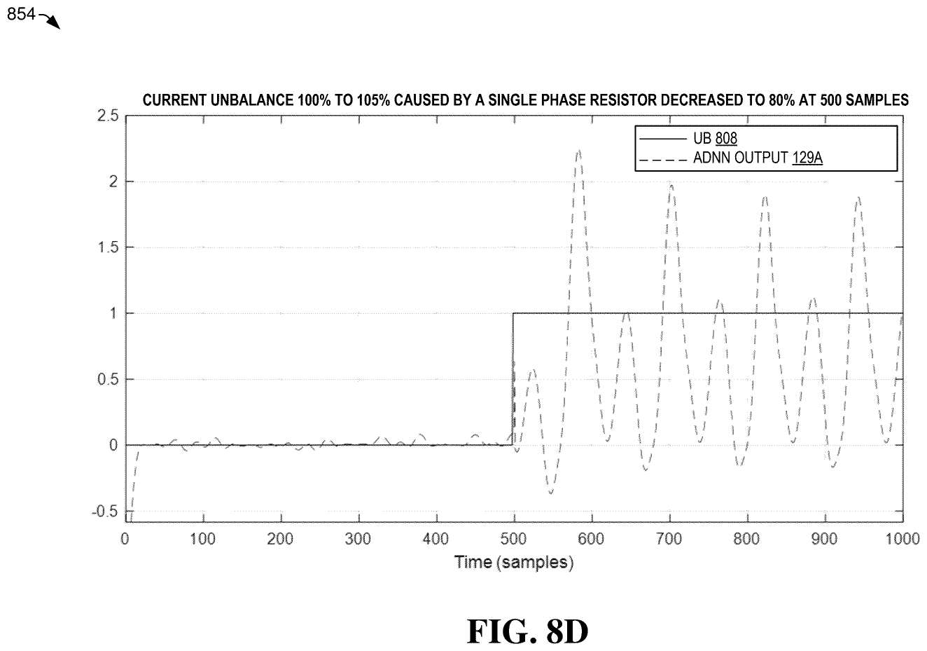

Referring to FIG. 8A, a graph 800 depicts an example of the ADNN output 129A of an ADNN 132A configured to detect an anomaly type 134A (e.g., TT short faults) for sensor input 131A corresponding to anomaly events (e.g., TT short faults) of the anomaly type 134A.

The graph 800 includes TT 802 having a first value (e.g., 1) when the electrical machine 106A is experiencing anomaly events of the anomaly type 134A (e.g., TT faults), and a second value (e.g., 0) when the electrical machine 106A is not experiencing anomaly events of the anomaly type 134A. During validation of the ADNN 132A, the TT 802 corresponds to the reference output 604. The ADNN output 129A persistently stays within the anomaly range 262A (e.g., 1±0.2) when the electrical machine 106A experiences anomaly events of the anomaly type 134A (e.g., TT faults).

Referring to FIG. 8B, a graph 850 depicts an example of the ADNN output 129A of an ADNN 132A, that has been trained to detect an anomaly type 134A (e.g., TT faults), in response to processing sensor input 131A that has anomaly events of the anomaly type 134B (e.g., grounding faults) instead of the anomaly type 134A (e.g., TT faults). As compared to FIG. 8A in which the ADNN 132A that has been trained to detect TT faults generates output persistently within the anomaly range 262A (e.g., 1±0.2) for sensor input 131A that has TT faults, in FIG. 8B the output is primarily outside of the anomaly range 262A for sensor input 131A that has grounding faults, indicating that TT faults are not detected.

The graph 850 includes GND 804 having a first value (e.g., 1) when the electrical machine 106A is experiencing anomaly events of the anomaly type 134B (e.g., grounding faults), and a second value (e.g., 0) when the electrical machine 106A is not experiencing anomaly events of the anomaly type 134B. The ADNN output 129A transiently passes through the anomaly range 262A (e.g., 1±0.2) when the electrical machine 106A experiences anomaly events of the anomaly type 134B (e.g., grounding faults). Because the ADNN output 129A does not stay within the anomaly range 262A for at least the detection sample count 264 of consecutive samples of the sensor input 131A, the ADNN output analyzer 136 determines that the anomaly type 134A is not detected.

Referring to FIG. 8C, a graph 852 depicts an example of the ADNN output 129A of an ADNN 132A, that has been trained to detect an anomaly type 134A (e.g., TT faults), in response to processing sensor input 131A that has anomaly events of the anomaly type 134C (e.g., OW faults) instead of the anomaly type 134A (e.g., TT faults). As compared to FIG. 8A in which the ADNN 132A that has been trained to detect TT faults generates output persistently within the anomaly range 262A (e.g., 1±0.2) for sensor input 131A that has TT faults, in FIG. 8C the output is primarily outside of the anomaly range 262A for sensor input 131A that has OW faults, indicating that TT faults are not detected.

The graph 852 includes OW 806 having a first value (e.g., 1) when the electrical machine 106A is experiencing anomaly events of the anomaly type 134C (e.g., OW faults), and a second value (e.g., 0) when the electrical machine 106A is not experiencing anomaly events of the anomaly type 134C. The ADNN output 129A transiently passes through the anomaly range 262A (e.g., 1±0.2) when the electrical machine 106A experiences anomaly events of the anomaly type 134C (e.g., OW). Because the ADNN output 129A does not stay within the anomaly range 262A for at least the detection sample count 264 of consecutive samples of the sensor input 131A, the ADNN output analyzer 136 determines that the anomaly type 134A is not detected.

Referring to FIG. 8D, a graph 854 depicts an example of the ADNN output 129A of an ADNN 132A, that has been trained to detect an anomaly type 134A (e.g., TT faults), in response to processing sensor input 131A that has anomaly events of another anomaly type (e.g., current imbalance) instead of the anomaly type 134A (e.g., TT faults). As compared to FIG. 8A in which the ADNN 132A that has been trained to detect TT faults generates output persistently within the anomaly range 262A (e.g., 1±0.2) for sensor input 131A that has TT faults, in FIG. 8D the output is primarily outside of the anomaly range 262A for sensor input 131A that has current imbalance, indicating that TT faults are not detected.

The graph 854 includes UB 808 having a first value (e.g., 1) when the electrical machine 106A is experiencing anomaly events of the other anomaly type (e.g., current unbalance), and a second value (e.g., 0) when the electrical machine 106A is not experiencing anomaly events of the other anomaly type. The ADNN output 129A transiently passes through the anomaly range 262A (e.g., 1±0.2) when the electrical machine 106A experiences anomaly events of the other anomaly type (e.g., current unbalance). Because the ADNN output 129A does not stay within the anomaly range 262A for at least the detection sample count 264 of consecutive samples of the sensor input 131A, the ADNN output analyzer 136 determines that the anomaly type 134A is not detected.

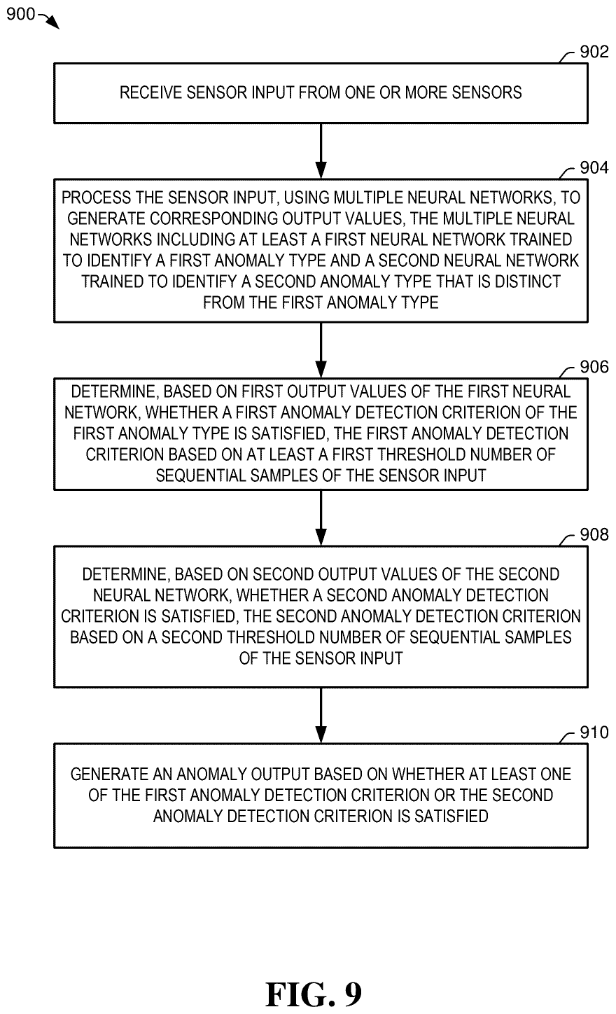

FIG. 9 is a flow chart that illustrates an example of a method 900 of sensor input based anomaly detection. The method 900 can be initiated, performed, or controlled by one or more processors executing instructions, or by circuitry configured to cause performance of one or more operations, such as resides within the ADNN output analyzer 136, the anomaly detector 130, the one or more ADNNs 132, the system 100 of FIG. 1, or a combination thereof.

The method 900 includes, at block 902, receiving sensor input from one or more sensors. For example, the anomaly detector 130 receives the sensor input 131A from the one or more sensors 120A that monitor operation of the electrical machine 106A, as described with reference to FIG. 1.

The method 900 also includes, at block 904, processing the sensor input, using multiple neural networks, to generate corresponding output values, the multiple neural networks including at least a first neural network trained to identify a first anomaly type and a second neural network trained to identify a second anomaly type that is distinct from the first anomaly type. For example, the anomaly detector 130 processes the sensor input 131A using the one or more ADNNs 132 to generate corresponding output values. To illustrate, the anomaly detector 130 uses the ADNN 132A to process the sensor input 131A to generate the ADNN output 129A, uses the ADNN 132B to process the sensor input 131A to generate the ADNN output 129B, and so on, as described with reference to FIG. 1. The ADNN 132A is trained to identify an anomaly type 134A. The ADNN 132B is trained to identify an anomaly type 134B that is distinct from the anomaly type 134A.

The method 900 further includes, at block 906, determining, based on first output values of the first neural network, whether a first anomaly detection criterion of the first anomaly type is satisfied, the first anomaly detection criterion based on at least a first threshold number of sequential samples of the sensor input. For example, the anomaly detector 130 determines, based on the ADNN output 129A, whether the detection criterion 204A of the anomaly type 134A is satisfied, as described with reference to FIGS. 1-3. The detection criterion 204A is based on at least the detection sample count 264A.

The method 900 also includes, at block 908, determining, based on second output values of the second neural network, whether a second anomaly detection criterion is satisfied, the second anomaly detection criterion based on a second threshold number of sequential samples of the sensor input. For example, the anomaly detector 130 determines, based on the ADNN output 129B, whether the detection criterion 204B of the anomaly type 134B is satisfied, as described with reference to FIGS. 1-2B. The detection criterion 204B is based on at least the detection sample count 264B.

The method 900 further includes, at block 910, generating an anomaly output based on whether at least one of the first anomaly detection criterion or the second anomaly detection criterion is satisfied. For example, the ADNN output analyzer 136 generates an anomaly output 135A based on whether at least one of the detection criterion 204A or the detection criterion 204B is satisfied. To illustrate, the anomaly output 135A indicates that the anomaly type 134A is detected when the detection criterion 204A is satisfied and indicates that the anomaly type 134B is detected when the detection criterion 204B is satisfied.

In some implementations, the method 900 can include more, fewer, and/or different steps without departing from the scope of the subject disclosure. For example, the method 900 can also include providing the anomaly output 135A to a system controller 102 of FIG. 1 to send a control signal 151A to a machine controller 104A to perform a remedial action related to the electrical machine 106A based on whether at least one of the detection criterions 204 is satisfied. The remedial action includes disabling the electrical machine 106A, reducing power to the electrical machine 106A, adjusting power demand of the electrical machine 106A, adjusting a voltage of the electrical machine 106A, adjusting a frequency of the electrical machine 106A, adjusting an input current to the electrical machine 106A, enabling an alternate electrical machine 106B, or a combination thereof. In some examples, the anomaly output 135A includes (or a control signal 151 generates) a log entry, an alert, or both, to initiate a future remedial action based on whether at least one of the detection criterions 204 is satisfied.

In some aspects, the sensor input 131A indicates at least one of current, voltage, frequency, vibration, or temperature associated with the electrical machine 106A. In some implementations, the ADNN 132A is used to process the sensor input 131A using a sliding window of a most recent set of samples of the sensor input 131A, and the ADNN 132B is used to process the sensor input 131A using the sliding window of the most recent set of samples.

The method 900 can be implemented to realize one or more of the technical advantages described in more detail above. For example, the method 900 can enable detection of an electrical machine 106 experiencing events associated with an anomaly type 134 in real-time without taking the electrical machine 106 off-line. In some aspects, an anomaly type 134 can be detected early prior to the electrical machine 106 becoming inoperable. In some implementations, an ADNN 132 is trained to identify complex relations between sensor input 131 to identify an anomaly type 134. An ADNN 132 can be added, upgraded, or removed in the anomaly detector 130 without having to retrain other ADNNs 132. Having specialized ADNNs 132 can reduce overall network complexity and increase detection accuracy, as compared to having a single large neural network to identify all anomaly types.

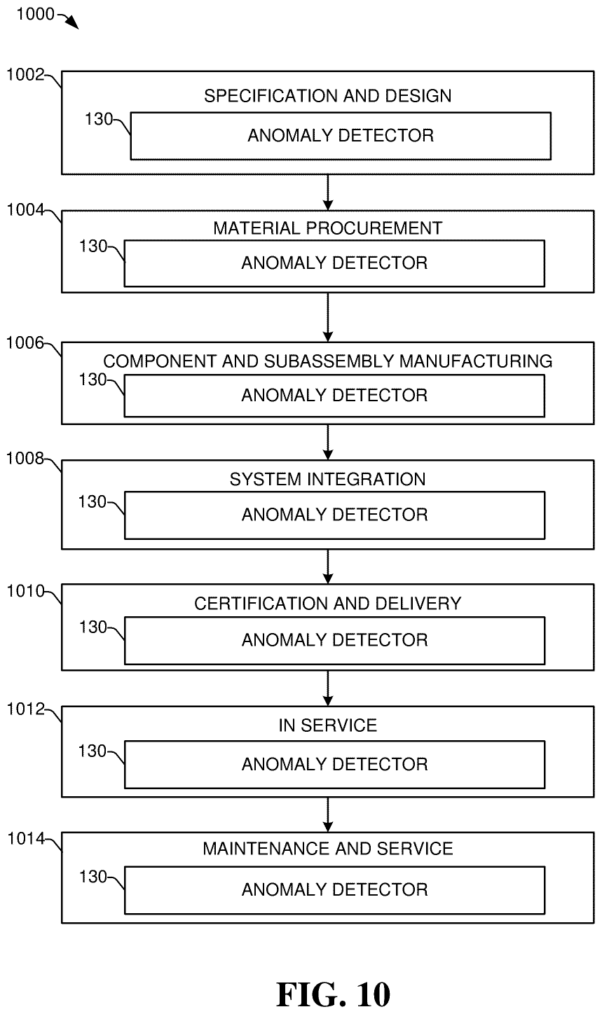

Referring to FIG. 10, a flowchart illustrative of a life cycle of an aircraft that includes an anomaly detector 130 is shown and designated 1000. During pre-production, the exemplary method 1000 includes, at 1002, specification and design of an aircraft. During specification and design of the aircraft, the method 1000 may include specification and design of the anomaly detector 130. At 1004, the method 1000 includes material procurement, which may include procuring materials for the anomaly detector 130.

During production, the method 1000 includes, at 1006, component and subassembly manufacturing and, at 1008, system integration of the aircraft. For example, the method 1000 may include component and subassembly manufacturing of the anomaly detector 130 and system integration of the anomaly detector 130. At 1010, the method 1000 includes certification and delivery of the aircraft and, at 1012, placing the aircraft in service. Certification and delivery may include certification of the anomaly detector 130 to place the anomaly detector 130 in service. While in service by a customer, the aircraft may be scheduled for routine maintenance and service (which may also include modification, reconfiguration, refurbishment, and so on). At 1014, the method 1000 includes performing maintenance and service on the aircraft, which may include performing maintenance and service on the anomaly detector 130.

Each of the processes of the method 1000 may be performed or carried out by a system integrator, a third party, and/or an operator (e.g., a customer). For the purposes of this description, a system integrator may include without limitation any number of aircraft manufacturers and major-system subcontractors; a third party may include without limitation any number of venders, subcontractors, and suppliers; and an operator may be an airline, leasing company, military entity, service organization, and so on.

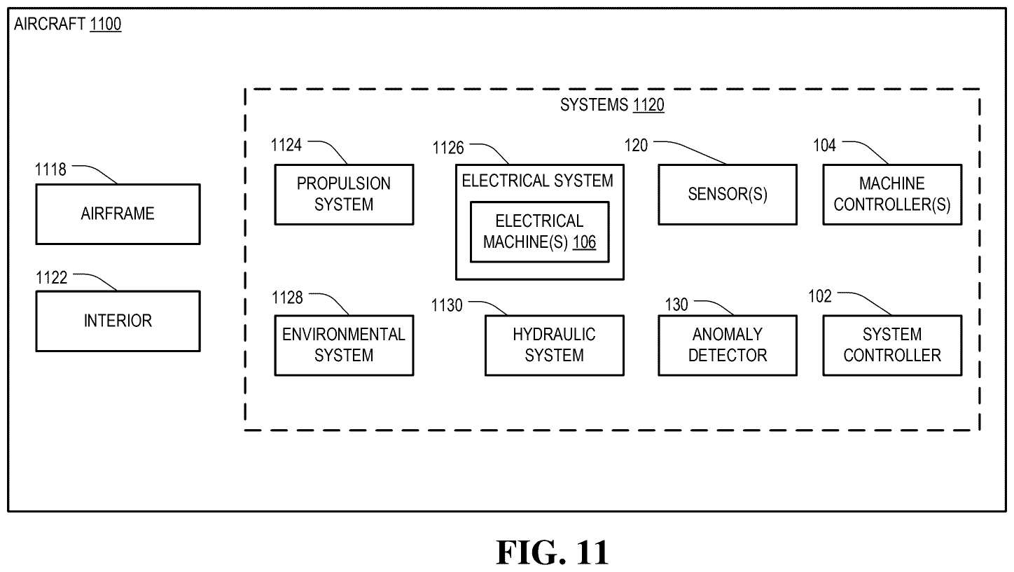

Aspects of the disclosure can be described in the context of an example of a vehicle. A particular example of a vehicle is an aircraft 1100 as shown in FIG. 11.

In the example of FIG. 11, the aircraft 1100 includes an airframe 1118 with a plurality of systems 1120 and an interior 1122. Examples of the plurality of systems 1120 include one or more of a propulsion system 1124, an electrical system 1126, an environmental system 1128, and a hydraulic system 1130. The electrical system 1126 includes the one or more electrical machines 106. Any number of other systems may be included. In an example, the systems 1120 include the one or more sensors 120, the one or more machine controllers 104, the anomaly detector 130, the system controller 102, or a combination thereof.

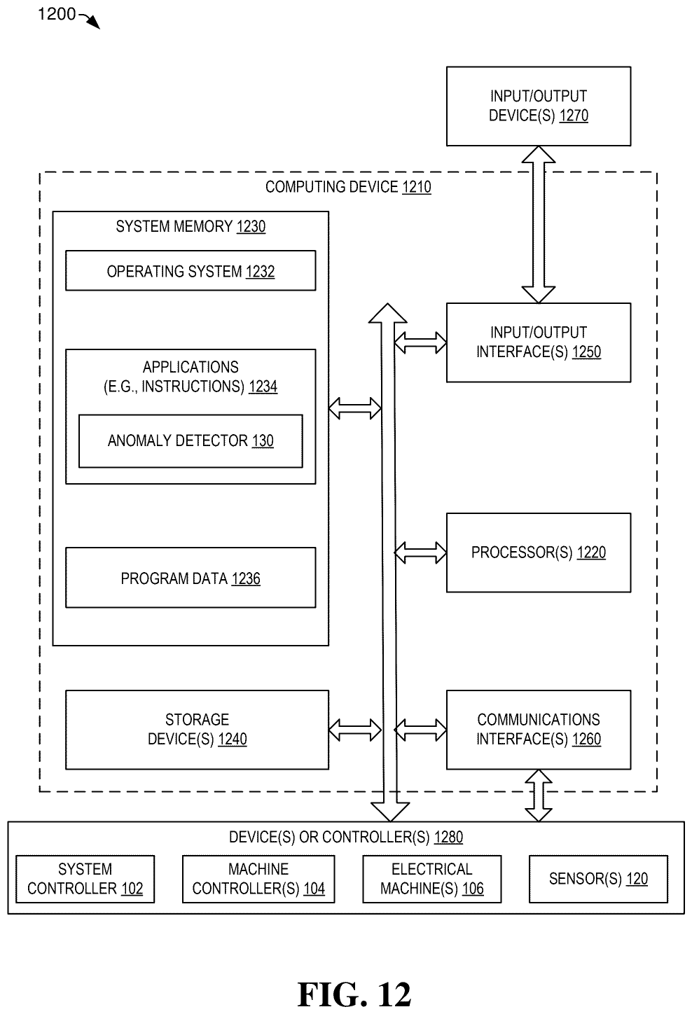

FIG. 12 is a block diagram of a computing environment 1200 including a computing device 1210 configured to support aspects of computer-implemented methods and computer-executable program instructions (or code) according to the present disclosure. For example, the computing device 1210, or portions thereof, is configured to execute instructions to initiate, perform, or control one or more operations described with reference to FIGS. 1-11.

The computing device 1210 includes one or more processors 1220. The processor(s) 1220 are configured to communicate with system memory 1230, one or more storage devices 1240, one or more input/output interfaces 1250, one or more communications interfaces 1260, or any combination thereof. The system memory 1230 includes volatile memory devices (e.g., random access memory (RAM) devices), nonvolatile memory devices (e.g., read-only memory (ROM) devices, programmable read-only memory, and flash memory), or both. The system memory 1230 stores an operating system 1232, which may include a basic input/output system for booting the computing device 1210 as well as a full operating system to enable the computing device 1210 to interact with users, other programs, and other devices. The system memory 1230 stores system (program) data 1236, such as data used or generated by the anomaly detector 130.

The system memory 1230 includes one or more applications 1234 (e.g., sets of instructions) executable by the processor(s) 1220. As an example, the one or more applications 1234 include instructions executable by the processor(s) 1220 to initiate, control, or perform one or more operations described with reference to FIGS. 1-11. To illustrate, the one or more applications 1234 include instructions executable by the processor(s) 1220 to initiate, control, or perform one or more operations described with reference to the anomaly detector 130, the ADNN output analyzer 136, the one or more ADNNs 132, or a combination thereof. The processor(s) 1220 can be implemented as a single processor or as multiple processors, such as in a multi-core configuration, a multi-processor configuration, a distributed computing configuration, a cloud computing configuration, or any combination thereof. In some implementations, one or more portions of the anomaly detector 130 are implemented by the processor(s) 1220 using dedicated hardware, firmware, or a combination thereof.

In a particular implementation, the system memory 1230 includes a non-transitory, computer readable medium storing the instructions that, when executed by the processor(s) 1220, cause the processor(s) 1220 to initiate, perform, or control operations to perform sensor input based anomaly detection. The operations include receiving sensor input (e.g., the sensor input 131A) from one or more sensors (e.g., the one or more sensors 120A). The operations also include processing the sensor input, using multiple neural networks (e.g., the ADNNs 132), to generate corresponding output values (e.g., the ADNN outputs 129). The multiple neural networks include at least a first neural network (e.g., the ADNN 132A) trained to identify a first anomaly type (e.g., the anomaly type 134A) and a second neural network (e.g., the ADNN 132B) trained to identify a second anomaly type (e.g., the anomaly type 134B) that is distinct from the first anomaly type. The operations further include determining, based on first output values (e.g., the ADNN output 129A) of the first neural network, whether a first anomaly detection criterion (e.g., the detection criterion 204A) of the first anomaly type is satisfied. The first anomaly detection criterion is based on at least a first threshold number of sequential samples (e.g., the detection sample count 264A) of the sensor input. The operations also include determining, based on second output values (e.g., the ADNN output 129B) of the second neural network, whether a second anomaly detection criterion (e.g., the detection criterion 204B) is satisfied. The second anomaly detection criterion is based on a second threshold number of sequential samples (e.g., the detection sample count 264B) of the sensor input. The operations further include generating an anomaly output (e.g., the anomaly output 135A) based on whether at least one of the first anomaly detection criterion or the second anomaly detection criterion is satisfied.

The one or more storage devices 1240 include nonvolatile storage devices, such as magnetic disks, optical disks, or flash memory devices. In a particular example, the storage devices 1240 include both removable and non-removable memory devices. The storage devices 1240 are configured to store an operating system, images of operating systems, applications (e.g., one or more of the applications 1234), and program data (e.g., the program data 1236). In a particular aspect, the system memory 1230, the storage devices 1240, or both, include tangible computer-readable media. In a particular aspect, one or more of the storage devices 1240 are external to the computing device 1210.

The one or more input/output interfaces 1250 enable the computing device 1210 to communicate with one or more input/output devices 1270 to facilitate user interaction. For example, the one or more input/output interfaces 1250 can include a display interface, an input interface, or both. For example, the input/output interface 1250 is adapted to receive input from a user, to receive input from another computing device, or a combination thereof. In some implementations, the input/output interface 1250 conforms to one or more standard interface protocols, including serial interfaces (e.g., universal serial bus (USB) interfaces or Institute of Electrical and Electronics Engineers (IEEE) interface standards), parallel interfaces, display adapters, audio adapters, or custom interfaces (“IEEE” is a registered trademark of The Institute of Electrical and Electronics Engineers, Inc. of Piscataway, New Jersey). In some implementations, the input/output device 1270 includes one or more user interface devices and displays, including some combination of buttons, keyboards, pointing devices, displays, speakers, microphones, touch screens, and other devices.

The processor(s) 1220 are configured to communicate with devices or controllers 1280 via the one or more communications interfaces 1260. For example, the one or more communications interfaces 1260 can include a network interface. The devices or controllers 1280 can include, for example, the one or more sensors 120, the one or more electrical machines 106, the one or more machine controllers 104, the system controller 102, one or more other devices, or any combination thereof.

In conjunction with the described systems and methods, an apparatus for sensor input based anomaly detection is disclosed that includes means for receiving sensor input from one or more sensors. In some implementations, the means for receiving corresponds to the one or more ADNNs 132, the memory buffer 138, the ADNN output analyzer 136, the anomaly detector 130, the system 100 of FIG. 1, the computing device 1210, the processor(s) 1220, the one or more communications interfaces 1260, one or more other circuits or devices configured to receive sensor input, or a combination thereof.

The apparatus also includes means for processing the sensor input, using multiple neural networks, to generate corresponding output values, the multiple neural networks including at least a first neural network trained to identify a first anomaly type and a second neural network trained to identify a second anomaly type that is distinct from the first anomaly type. For example, the means for processing can correspond to the one or more ADNNs 132, the anomaly detector 130, the system 100 of FIG. 1, the computing device 1210, the processor(s) 1220, the one or more communications interfaces 1260, one or more other devices configured to process the sensor input using multiple neural networks, or a combination thereof.

The apparatus further includes means for determining, based on first output values of the first neural network, whether a first anomaly detection criterion of the first anomaly type is satisfied, the first anomaly detection criterion based on at least a first threshold number of sequential samples of the sensor input. For example, the means for determining can correspond to the ADNN output analyzer 136, the anomaly detector 130, the system 100 of FIG. 1, the computing device 1210, the processor(s) 1220, one or more other circuits or devices configured to determine whether an anomaly detection criterion is satisfied, or a combination thereof.

The apparatus also includes means for determining, based on second output values of the second neural network, whether a second anomaly detection criterion is satisfied, the second anomaly detection criterion based on a second threshold number of sequential samples of the sensor input. For example, the means for determining can correspond to the ADNN output analyzer 136, the anomaly detector 130, the system 100 of FIG. 1, the computing device 1210, the processor(s) 1220, one or more other circuits or devices configured to determine whether an anomaly detection criterion is satisfied, or a combination thereof.

The apparatus further includes means for generating an anomaly output based on whether at least one of the first anomaly detection criterion or the second anomaly detection criterion is satisfied. For example, the means for generating can correspond to the ADNN output analyzer 136, the anomaly detector 130, the system 100 of FIG. 1, the computing device 1210, the processor(s) 1220, one or more other circuits or devices configured to generate an anomaly output, or a combination thereof.

In some implementations, a non-transitory computer readable medium stores instructions that, when executed by one or more processors, cause the one or more processors to initiate, perform, or control operations to perform part or all of the functionality described above. For example, the instructions may be executable to implement one or more of the operations or methods of FIGS. 1-12. In some implementations, part or all of one or more of the operations or methods of FIGS. 1-12 may be implemented by one or more processors (e.g., one or more central processing units (CPUs), one or more graphics processing units (GPUs), one or more digital signal processors (DSPs)) executing instructions, by dedicated hardware circuitry, or any combination thereof.

Particular aspects of the disclosure are described below in sets of interrelated Examples:

According to Example 1, a device includes one or more processors configured to receive sensor input from one or more sensors; process the sensor input, using multiple neural networks, to generate corresponding output values, the multiple neural networks including at least a first neural network trained to identify a first anomaly type and a second neural network trained to identify a second anomaly type that is distinct from the first anomaly type; determine, based on first output values of the first neural network, whether a first anomaly detection criterion of the first anomaly type is satisfied, the first anomaly detection criterion based on at least a first threshold number of sequential samples of the sensor input; determine, based on second output values of the second neural network, whether a second anomaly detection criterion of the second anomaly type is satisfied, the second anomaly detection criterion based on at least a second threshold number of sequential samples of the sensor input; and generate an anomaly output based on whether at least one of the first anomaly detection criterion or the second anomaly detection criterion is satisfied.

Example 2 includes the device of Example 1, wherein the sensor input corresponds to operation of an electrical machine.

Example 3 includes the device of Example 2, wherein the electrical machine includes a motor, a generator, or both.

Example 4 includes the device of Example 2 or Example 3, wherein the anomaly output is provided to a system controller to generate a control signal to a machine controller to perform a remedial action related to the electrical machine based on whether at least one of the first anomaly detection criterion or the second anomaly detection criterion is satisfied.

Example 5 includes the device of Example 4, wherein the remedial action includes disabling the electrical machine, reducing power to the electrical machine, adjusting power demand of the electrical machine, adjusting a voltage of the electrical machine, adjusting a frequency of the electrical machine, adjusting an input current to the electrical machine, enabling an alternate electrical machine, or a combination thereof.

Example 6 includes the device of any of Examples 1 to 5, wherein the anomaly output includes a log entry, an alert, or both, to initiate a future remedial action based on whether at least one of the first anomaly detection criterion or the second anomaly detection criterion is satisfied.

Example 7 includes the device of any of Examples 1 to 6, wherein the sensor input indicates at least one of current, voltage, frequency, vibration, or temperature.

Example 8 includes the device of any of Examples 1 to 7, and further includes a memory configured to store a most recent set of samples of the sensor input, wherein the first neural network is configured to process the sensor input using a sliding window of the most recent set of samples, and wherein the second neural network is configured to process the sensor input using the sliding window of the most recent set of samples.

Example 9 includes the device of any of Examples 1 to 8, wherein the one or more processors are configured to train the first neural network using training data associated with one or more anomaly events of the first anomaly type; and validate the first neural network using validation data associated with one or more anomaly events of the first anomaly type and one or more anomaly events of the second anomaly type.

Example 10 includes the device of Example 9, wherein the one or more processors are configured to determine a first anomaly range based on validation output of the first neural network; and based on determining that the first output values of the first neural network match the first anomaly range for at least the first threshold number of sequential samples of the sensor input, determine that the first anomaly detection criterion is satisfied.

Example 11 includes the device of any of Examples 1 to 10, wherein the first anomaly type includes a fault type, a degradation type, or both.

According to Example 12, a method includes receiving sensor input from one or more sensors; processing the sensor input, using multiple neural networks, to generate corresponding output values, the multiple neural networks including at least a first neural network trained to identify a first anomaly type and a second neural network trained to identify a second anomaly type that is distinct from the first anomaly type; determining, based on first output values of the first neural network, whether a first anomaly detection criterion of the first anomaly type is satisfied, the first anomaly detection criterion based on at least a first threshold number of sequential samples of the sensor input; determining, based on second output values of the second neural network, whether a second anomaly detection criterion is satisfied, the second anomaly detection criterion based on a second threshold number of sequential samples of the sensor input; and generating an anomaly output based on whether at least one of the first anomaly detection criterion or the second anomaly detection criterion is satisfied.

Example 13 includes the method of Example 12, wherein the sensor input corresponds to operation of an electrical machine, and further comprising providing the anomaly output to a system controller to send a control signal to a machine controller to perform a remedial action related to the electrical machine based on whether at least one of the first anomaly detection criterion or the second anomaly detection criterion is satisfied.

Example 14 includes the method of Example 13, wherein the remedial action includes disabling the electrical machine, reducing power to the electrical machine, adjusting power demand of the electrical machine, adjusting a voltage of the electrical machine, adjusting a frequency of the electrical machine, adjusting an input current to the electrical machine, enabling an alternate electrical machine, or a combination thereof.

Example 15 includes the method of any of Examples 12 to 14, wherein the anomaly output includes a log entry, an alert, or both, to initiate a future remedial action based on whether at least one of the first anomaly detection criterion or the second anomaly detection criterion is satisfied.

Example 16 includes the method of any of Examples 12 to 15, wherein the sensor input indicates at least one of current, voltage, frequency, vibration, or temperature.

Example 17 includes the method of any of Examples 12 to 16, wherein the first neural network is used to process the sensor input using a sliding window of a most recent set of samples of the sensor input, and wherein the second neural network is used to process the sensor input using the sliding window of the most recent set of samples.

According to Example 18, an aircraft includes an electrical machine; one or more sensors coupled to the electrical machine and configured to generate sensor input corresponding to operation of the electrical machine; and an anomaly detector configured to process the sensor input, using multiple neural networks, to generate corresponding output values, the multiple neural networks including at least a first neural network trained to identify a first anomaly type and a second neural network trained to identify a second anomaly type that is distinct from the first anomaly type; determine, based on first output values of the first neural network, whether a first anomaly detection criterion of the first anomaly type is satisfied, the first anomaly detection criterion based on at least a first threshold number of sequential samples of the sensor input; determine, second output values of the second neural network, whether a second anomaly detection criterion of the second anomaly type is satisfied, the second anomaly detection criterion based on at least a second threshold number of sequential samples of the sensor input; and generate an anomaly output based on whether at least one of the first anomaly detection criterion or the second anomaly detection criterion is satisfied.

Example 19 includes the aircraft of Example 18, wherein the electrical machine includes a motor, a generator, or both.

Example 20 includes the aircraft of Example 18 or Example 19, further comprising a system controller configured to send a control signal to a machine controller to perform a remedial action related to the electrical machine based on the anomaly output.

The illustrations of the examples described herein are intended to provide a general understanding of the structure of the various implementations. The illustrations are not intended to serve as a complete description of all of the elements and features of apparatus and systems that utilize the structures or methods described herein. Many other implementations may be apparent to those of skill in the art upon reviewing the disclosure. Other implementations may be utilized and derived from the disclosure, such that structural and logical substitutions and changes may be made without departing from the scope of the disclosure. For example, method operations may be performed in a different order than shown in the figures or one or more method operations may be omitted. Accordingly, the disclosure and the figures are to be regarded as illustrative rather than restrictive.

Moreover, although specific examples have been illustrated and described herein, it should be appreciated that any subsequent arrangement designed to achieve the same or similar results may be substituted for the specific implementations shown. This disclosure is intended to cover any and all subsequent adaptations or variations of various implementations. Combinations of the above implementations, and other implementations not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single implementation for the purpose of streamlining the disclosure. Examples described above illustrate but do not limit the disclosure. It should also be understood that numerous modifications and variations are possible in accordance with the principles of the present disclosure. As the following claims reflect, the claimed subject matter may be directed to less than all of the features of any of the disclosed examples. Accordingly, the scope of the disclosure is defined by the following claims and their equivalents.

What is claimed is:

1. A device comprising:
one or more processors configured to:
receive sensor input from one or more sensors;
process the sensor input, using multiple neural networks, to generate corresponding output values, the multiple neural networks including at least a first neural network trained to identify a first anomaly type and a second neural network trained to identify a second anomaly type that is distinct from the first anomaly type;
determine, based on first output values of the first neural network, whether a first anomaly detection criterion of the first anomaly type is satisfied, the first anomaly detection criterion based on at least a first threshold number of sequential samples of the sensor input;
determine, based on second output values of the second neural network, whether a second anomaly detection criterion of the second anomaly type is satisfied, the second anomaly detection criterion based on at least a second threshold number of sequential samples of the sensor input; and
generate an anomaly output based on whether at least one of the first anomaly detection criterion or the second anomaly detection criterion is satisfied.

2. The device of claim 1, wherein the sensor input corresponds to operation of an electrical machine.

3. The device of claim 2, wherein the electrical machine includes a motor, a generator, or both.

4. The device of claim 2, wherein the anomaly output is provided to a system controller to generate a control signal to a machine controller to perform a remedial action related to the electrical machine based on whether at least one of the first anomaly detection criterion or the second anomaly detection criterion is satisfied.

5. The device of claim 4, wherein the remedial action includes disabling the electrical machine, reducing power to the electrical machine, adjusting power demand of the electrical machine, adjusting a voltage of the electrical machine, adjusting a frequency of the electrical machine, adjusting an input current to the electrical machine, enabling an alternate electrical machine, or a combination thereof.

6. The device of claim 1, wherein the anomaly output includes a log entry, an alert, or both, to initiate a future remedial action based on whether at least one of the first anomaly detection criterion or the second anomaly detection criterion is satisfied.

7. The device of claim 1, wherein the sensor input indicates at least one of current, voltage, frequency, vibration, or temperature.

8. The device of claim 1, further comprising a memory configured to store a most recent set of samples of the sensor input, wherein the first neural network is configured to process the sensor input using a sliding window of the most recent set of samples, and wherein the second neural network is configured to process the sensor input using the sliding window of the most recent set of samples.

9. The device of claim 1, wherein the one or more processors are configured to:
train the first neural network using training data associated with one or more anomaly events of the first anomaly type; and
validate the first neural network using validation data associated with one or more anomaly events of the first anomaly type and one or more anomaly events of the second anomaly type.

10. The device of claim 9, wherein the one or more processors are configured to:
determine a first anomaly range based on validation output of the first neural network; and
based on determining that the first output values of the first neural network match the first anomaly range for at least the first threshold number of sequential samples of the sensor input, determine that the first anomaly detection criterion is satisfied.

11. The device of claim 1, wherein the first anomaly type includes a fault type, a degradation type, or both.

12. A method comprising:
receiving sensor input from one or more sensors;
processing the sensor input, using multiple neural networks, to generate corresponding output values, the multiple neural networks including at least a first neural network trained to identify a first anomaly type and a second neural network trained to identify a second anomaly type that is distinct from the first anomaly type;
determining, based on first output values of the first neural network, whether a first anomaly detection criterion of the first anomaly type is satisfied, the first anomaly detection criterion based on at least a first threshold number of sequential samples of the sensor input;
determining, based on second output values of the second neural network, whether a second anomaly detection criterion is satisfied, the second anomaly detection criterion based on a second threshold number of sequential samples of the sensor input; and
generating an anomaly output based on whether at least one of the first anomaly detection criterion or the second anomaly detection criterion is satisfied.

13. The method of claim 12, wherein the sensor input corresponds to operation of an electrical machine, and further comprising providing the anomaly output to a system controller to send a control signal to a machine controller to perform a remedial action related to the electrical machine based on whether at least one of the first anomaly detection criterion or the second anomaly detection criterion is satisfied.

14. The method of claim 13, wherein the remedial action includes disabling the electrical machine, reducing power to the electrical machine, adjusting power demand of the electrical machine, adjusting a voltage of the electrical machine, adjusting a frequency of the electrical machine, adjusting an input current to the electrical machine, enabling an alternate electrical machine, or a combination thereof.

15. The method of claim 12, wherein the anomaly output includes a log entry, an alert, or both, to initiate a future remedial action based on whether at least one of the first anomaly detection criterion or the second anomaly detection criterion is satisfied.

16. The method of claim 12, wherein the sensor input indicates at least one of current, voltage, frequency, vibration, or temperature.

17. The method of claim 12, wherein the first neural network is used to process the sensor input using a sliding window of a most recent set of samples of the sensor input, and wherein the second neural network is used to process the sensor input using the sliding window of the most recent set of samples.

18. An aircraft comprising:
an electrical machine;
one or more sensors coupled to the electrical machine and configured to generate sensor input corresponding to operation of the electrical machine; and
an anomaly detector configured to:
process the sensor input, using multiple neural networks, to generate corresponding output values, the multiple neural networks including at least a first neural network trained to identify a first anomaly type and a second neural network trained to identify a second anomaly type that is distinct from the first anomaly type;
determine, based on first output values of the first neural network, whether a first anomaly detection criterion of the first anomaly type is satisfied, the first anomaly detection criterion based on at least a first threshold number of sequential samples of the sensor input;
determine, second output values of the second neural network, whether a second anomaly detection criterion of the second anomaly type is satisfied, the second anomaly detection criterion based on at least a second threshold number of sequential samples of the sensor input; and
generate an anomaly output based on whether at least one of the first anomaly detection criterion or the second anomaly detection criterion is satisfied.

19. The aircraft of claim 18, wherein the electrical machine includes a motor, a generator, or both.

20. The aircraft of claim 18, further comprising a system controller configured to send a control signal to a machine controller to perform a remedial action related to the electrical machine based on the anomaly output.
